(19) United States
(12) Patent Application Publication
(10) Pub. No.: US 2023/0247986 A1
(43) Pub. Date: Aug. 10, 2023

(54) AQUEOUS CAPSULE SUSPENSION CONCENTRATES COMPRISING BIODEGRADABLE ESTER GROUPS

(71) Applicant: BAYER AKTIENGESELLSCHAFT, Leverkusen (DE)

(72) Inventors: Jens KRAUSE, Leverkusen (DE); Holger EGGER, Koeln (DE)

(21) Appl. No.: 18/003,063

(22) PCT Filed: Jun. 23, 2021
(86) PCT No.: PCT/EP2021/067172

§ 371 Date: Dec. 22, 2022

(30) Foreign Application Priority Data
Jun. 26, 2020 (EP) 20182559.3

(51) Int. Cl. A01N 25/28; B01J 13/14

(52) U.S. Cl. CPC A01N 25/28; B01J 13/14

(57) ABSTRACT

The present invention relates to aqueous capsule suspension concentrates based on polyurea shell material containing the reaction product of a NCO terminated polyester-polyol polyisocyanate prepolymer with a polyamine with less than 3 amino groups reactive towards NCO groups and an encapsulated hydrophobic core containing an ingredient, e.g. an active ingredient, in particular an agrochemical ingredient, the production thereof and the use thereof as a formulation, in particular agrochemical formulation, that provide better biodegradability.

The present invention relates to aqueous capsule suspension concentrates based on polyurea shell material containing the reaction product of a NCO terminated polyester-polyol polyisocyanate prepolymer with a polyamine with less than 3 amino groups reactive towards NCO groups and an encapsulated hydrophobic core containing an ingredient, e.g. an active ingredient, in particular an agrochemical ingredient, the production thereof and the use thereof as a formulation, in particular agrochemical formulation, that provide better biodegradability.

Microcapsules are spherical objects which consist of a core and a wall material surrounding the core, wherein the core in principal can be a solid, liquid or gaseous component which is surrounded by the solid wall material. For many applications the wall is formed by a polymer material. Microcapsules usually have a volume average diameter from 1 to 1000 μm.

A multitude of shell materials is known for producing the wall of microcapsules. The shell can consist either of natural, semisynthetic or synthetic materials. Natural shell materials are, for example, gum arabic, agar agar, agarose, maltodextrins, alginic acid or its salts, e.g. sodium alginate or calcium alginate, fats and fatty acids, cetyl alcohol, collagen, chitosan, lecithins, gelatin, albumin, shellac, polysaccharides, such as starch or dextran, polypeptides, protein hydrolyzates, sucrose and waxes. Semisynthetic shell materials are inter alia chemically modified celluloses, in particular cellulose esters and cellulose ethers, e.g. cellulose acetate, ethyl cellulose, hydroxypropylcellulose, hydroxypropylmethylcellulose and carboxymethyl-cellulose, and also starch derivatives, in particular starch ethers and starch esters. Synthetic shell materials are, for example, polymers, such as polyacrylates, polyamides, polyvinyl alcohols, polyvinylpyrrolidones or polyureas.

Depending on the type of shell material and the production process, microcapsules are formed in each case with different properties, such as diameter, size distribution, thickness of the wall and physical and/or chemical properties.

Polyurea core-shell microcapsules obtained by reaction of at least one diisocyanate and at least one polyamine are well known in the art, for example from WO 2011/161229 or WO 2011/160733. According to WO 2011/161229 or WO 2011/160733 the polyurea microcapsules are prepared in presence of polyvinylpyrrolidone (PVP) as a protective colloid.

The development of biodegradable microcapsules was carried out mainly for drug transport and in-vivo release applications. Attention toward biodegradable capsules was increased since environmental aspects of polymers started to be discussed in the public and efforts were made to reduce environmental pollution.

The closest prior art are WO2017/089116 and WO2017/089115 using polyester-modified polyisocyanates that are cured with amines. The application gives no further data on biodegradability, however, polyesters are known to undergo hydrolysis after some time in the environment.

WO2017/089116 discloses the encapsulation of a hydrophobic core with a polyester-urethane having a least 2 functional NCO groups reacted with an amine having a molecular weight of a least 300 g/mol and at least 3 functional amino groups. A disadvantage of this application is that these high functionalities result in very dense capsules that have a too slow release behavior of the active ingredient. Therefore, lower cross linking densities are needed.

WO2017/089117 discloses the encapsulation of a hydrophilic core with a polyester-urethane having a least 2 functional NCO groups reacted with isocyanate reactive group of at least two functional groups. However, most active ingredients that target a controlled release behavior are in a hydrophobic core encapsulation. In most cases they are either hydrophobic or dissolved in a hydrophobic oil.

A further disadvantage of the two mentioned applications is that the NCO described in the above cited references is not suitable for most active ingredients. The NCO content in all references was below 10% (after evaporation of the solvents) which may result in a not complete encapsulation of the active ingredients and portions or parts of the active ingredients remain unencapsulated. This results in formulations with a high tendency to crystallization that are not long term stable.

A further disadvantage is that the evaporation of a solvent increases the costs of making the NCO prepolymers.

Furthermore, the viscosity of the solvent free polymers is very high and leads to processing issues making the capsule materials. Hence increased amounts of unencapsulated active ingredients can be found and/or the shell is not fully reacted with NCO reactive group thus resulting in an instable formulation.

Furthermore, it must be ensured not having unreacted NCO and amino groups in the formulation as this would result in a very unfavorable classification of the formulation as these groups are very eye irritant and toxic if unreacted.

Moreover, the shell should be biodegradable or at least partially biodegradable. Further, the microcapsule suspension concentrates and the active ingredient loaded microcapsules provide an improved volatility of active ingredient.

The problem was solved by the capsule suspension concentrates (CS) according to the invention.

The present invention relates to microcapsules comprising a hydrophobic capsule core and a polymeric shell, wherein the biodegradable or at least partially biodegradable shell comprises in polymerized form
a) at least one NCO terminatedpolyester-polyol polyisocyanate prepolymer containing at least 2 isocyanate groups and a NCO content >17 wt.-% and a viscosity at 30° C. according to DIN EN ISO 2884-1 <2500 mPas, and
b) at least one compound selected from a polyamine with less than 3 amino groups reactive towards NCO groups and/or from other NCO reactive groups selected of alkyl, cycloalkyl, aryl groups with terminal OH or SH groups and/or water.

In a preferred embodiment the viscosity of a) is from 400 to 2500 mPas, more preferred 800 to 2000 mPas, and most preferred from 800 mPas to 1500 mPas, In a preferred embodiment the reaction product of a) and b) is degradable according to OECD 301B under aerobic conditions to more than 15% after 14 days and more than 25% after 28 days.

The present invention further relates to microcapsule dispersions, comprising microcapsules according to the present invention, wherein the capsule core contains essentially a least one component, preferably an active ingredient, which can be dissolved or dispersed in an organic solvent. The microcapsule formulation is a suspension concentrate (CS) in water.

The present invention further relates to microcapsule dispersions, comprising microcapsules comprising a hydrophobic capsule core and a polymeric shell, wherein the biodegradable or at least partially biodegradable shell comprises in polymerized form
a) at least one NCO terminatedpolyester-polyol polyisocyanate prepolymer containing at least 2 isocyanate groups and a NCO content >17 wt.-% and a viscosity at 30° C. according to DIN EN ISO 2884-1 of <2500 mPas, and
b) at least one compound selected from a polyamine with less than 3 amino groups reactive towards NCO groups and/or from other NCO reactive groups selected of alkyl, cycloalkyl, aryl groups with terminal OH or SH groups and/or water,
   and the microcapsule further comprises
c) at least one agrochemical active ingredient,
d) optionally one or more water immiscible organic solvents;
f) at least one protective colloid, and
g) at least one additive.

Water as ingredient i) is added to volume (11) if not otherwise indicated).

In a preferred embodiment the viscosity of a) is from 400 to 2500 mPas, more preferred 800 to 2000 mPas, and most preferred from 800 mPas to 1500 mPas,

If the agrochemical compound c) is a herbicide, it is preferred that also a safener is comprised, wherein the safener can be enclosed in the capsule along with the other active ingredient, separately encapsulated, or not encapsulated at all.

The particle size is determined according to CIPAC (CIPAC=Collaborative International Pesticides Analytical Council; www.cipac.org) Method MT 187 as d50 or d90=active ingredient particle size (laser scattering of 50% or 90% of all volume particles). The median particle size refers to the d50 value.

The particles (microcapsules according to the present invention) of the CS have a median particle size d50 which is generally between 1 and 50 μm, preferably 1 to 20 μm, most preferably between 3 and 15 μm (micrometer).

The present invention further relates to microcapsules obtained by the processes according to the invention.

The present invention further relates to the use of microcapsules or microcapsules according to the invention or obtained by the processes according to the invention in a plant protection composition.

The present invention further relates to the use of the microcapsules according to the invention or obtained by the processes according to the invention in agrochemical formulations.

The present invention further relates to the use of the microcapsules according to the invention or obtained by the processes according to the invention in the fields of crop protection, seed coatings, and non-agricultural pest, plant disease and/or weed control.

The microcapsules according to the invention have the following advantages:
Small particle size and narrow particle size distribution
Good tightness and mechanical stability
Sprayable
Partially made of biodegradable building blocks

The terms “biodegradation” or “biodegradability” are synonyms and mean in the sense of the invention that the polymers decompose in an appropriate and demonstrable period of time when exposed to the effects of the environment. The degradation mechanism can be hydrolytic and/or oxidative, and is based mainly on exposure to microorganisms, such as bacteria, yeasts, fungi, and algae. An example of a method for determining biodegradability mixes the polymer with compost and stores it for a particular time. According to ASTM D5338, ASTM D6400, EN 13432, and DIN V 54900, CO₂ free air, by way of example, is passed through ripened compost during the composting process, and this compost is subjected to a defined temperature program. Biodegradability is defined here by way of the ratio of the net amount of CO₂ liberated from the specimen (after deducting the amount of CO₂ liberated by the compost without the specimen) to the maximum possible amount of CO₂ liberated by the specimen (calculated from the carbon content of the specimen). Even after a few days of composting, biodegradable polymers generally show marked signs of degradation, for example fungal growth, cracking, and perforation. Alternative methods are described in OECD 301-307. The tests can be under aerobic or anaerobic conditions.

In another method of determining biodegradability, the polymer could be incubated with a certain amount of a suitable enzyme at a certain temperature for a defined period, and then the concentration of the organic degradation products dissolved in the incubation medium is determined. By way of example, by analogy with Y. Tokiwa et al., American Chemical Society Symposium 1990, Chapter 12, “Biodegradation of Synthetic Polymers Containing Ester Bonds” the polymer can be incubated for a number of hours at from 30 to 37° C. with a predetermined amount of a lipase, for example from Rhizopus arrhizus, Rhizopus delemar, Achromobacter sp., or Candida cylindracea, and the DOC value (dissolved organic carbon) can then be measured on the reaction mixture freed from insoluble constituents.

The present invention likewise provides a process for producing the capsule suspension concentrates according to the invention, characterized in that an active ingredient c), optionally dissolved in an organic, water-immiscible solvent d), is mixed with the isocyanate or isocyanate mixture a) and optionally with an organic solvent, the solution thus prepared is then emulsified in water comprising a protective colloid f), optionally in a mixture with further additives g). The Isocyanate a) is reacted with b) in the process either with b) being added into the water before emulsifying or being added after the emulsification step. Further additives g) are optionally added.

For production of the CS according to the invention, it is possible to use any apparatus customary for purposes of this kind that generates strong shear forces. Examples include rotor-stator mixers and jet dispersers.

In the performance of the process according to the invention, the ratio of NCO groups from component a) to NCO-reactive groups from component b) may be varied within a particular range. In general, 0.8 to 1.5 equivalents of amine or alcohol component are used per 1 mol of isocyanate. Preferably, the amounts of isocyanate and amine or alcohol are chosen such that equimolar amounts of isocyanate groups and of amino or hydroxyl groups are present.

In the performance of the process according to the invention, the reaction temperatures can be varied within a particular range.

The process according to the invention is generally conducted at temperatures between −10 and 80° C., preferably between 0° C. and 50° C., more preferably between 2° C. and 40° C., most preferably between 2° C. and 30° C. in the emulsification step. The final curing of the polymer shell forming the microcapsules is generally at temperatures between −10° C. and +80° C., preferably between 0° C. and 80° C., generally at temperatures between 0° C. and 80° C., preferably between 10° C. and 75° C.

Based on the amount of wall building components a) and b) and the obtained particle size (d0), a theoretical wall thickness can be calculated, wherein the density of the polymer is set as 1 (1 g/cm³). The calculated wall thickness of the capsules of the capsule suspension concentrates according to the invention is between 0.001 and 4 μm, preferably between 0.01 and 2 μm and most preferably between 0.01 and 1 μm (micrometer).

In the reaction of a) with b), the sum total of the number-average functionality X of isocyanate groups and isocyanate-reactive groups is 2≤X≤6, preferably 2≤X≤4.5, more preferably 2.0≤X≤3.5 and most preferably 2.2≤X≤2.8.

The “number-average functionality X” feature in the process according to the invention is illustrated as follows. It is the compound of higher functionality that is crucial here, and the result of subtracting 2 from the compound of lower functionality is added to the compound of higher functionality. If, for example, the (average) functionality of a) is 2.1 and that of b) is 2.6: 2.1−2=0.1. This difference is added to 2.6: 2.6+0.1=2.7. The number-average functionality is thus 2.7. Alternatively, if a) is 2.7 and b) is 2.3, the number-average functionality is found to be 2.7+2.3−2=3.0.

The capsule suspension concentrates according to the invention feature several advantages. For instance, they are capable of releasing the active components in the amount required in each case over a prolonged period. It is also favourable that the plant compatibility of the active ingredients present is improved, and volatility and hence damage to neighbouring crops are reduced. Moreover, the acute toxicity of the active components is reduced, and so the deployment of the microcapsule formulations is unproblematic to the operators even without any great safety precautions. Further, the capsules respectively their shells are biodegradable or at least partially biodegradable.

Useful compounds b) that can be used include aliphatic, aromatic, cyclic and alicyclic primary and secondary diamines, and also polyamines. b) preferably is an amine made according to Examples include ethylenediamine (1,2), diethylenetriamine, monoisopropylamine, 4-aminopyridine (4-AP), n-propylamine, ethylene- or propylenimine-based polyaziridine, bis(hexamethylene)triamine, ethylenediamine (EDA), trimethylenedipiperidine (TMDP), guanidine carbonate (GUCA), phenylenediamine, toluenediamine, 2,4-diamino-6-methyl-1,3,5-triazine, 1,2-diaminocyclohexane, 4,4′-diaminodiphenylmethane, 1,5-diaminonaphthalenisophoronediamine, diaminopropane, diaminobutane, piperazine, aminoethylenepiperazine (AEP), poly(propylene glycol) bis(2-aminopropyl ether) or o,o′-bis(2-aminopropyl)polypropylene glycol-block-polyethylene glycol-block-polypropylene glycol, hexamethylenediamine, bis(3-aminopropyl)amine, bis(2-methylaminoethyl)methylamine, 1,4-diaminocyclohexane, 3-amino-1-methylaminopropane, N-methylbis(3-aminopropyl)amine, 1,4-diamino-n-butane and 1,6-diamino-n-hexane or amines as disclosed in patent application EP19220150.7 based on the reaction product of polycaprolactame and an alcohol providing amino terminated groups Preferred are 1,6-Diaminohexane, ethylenediamine (1,2), diethylenetriamine or amines as disclosed in patent application EP19220150.7 based on the reaction product of polycaprolactame and an alcohol providing amino terminated groups are used.

Useful compounds having isocyanate-reactive group b) likewise include primary and secondary, aliphatic and aromatic dialcohols and polyalcohols. Examples include: ethanediol, propanediol (1,2), propanediol (1,3), butanediol (1,4), pentanediol (1,5), hexanediol (1,6), glycerol and diethylene glycol.

Compounds having isocyanate-reactive group b) also include amino alcohols. Examples include triethanolamine, monoethanolamine, triisopropanolamine, diisopropylamine, N-methylethanolamine, N-methyldiethanolamine.

In an alternative embodiment, water is used as isocyanate-reactive component b). It is reacted in situ with the isocyanate (poly/di) to give an amine (poly/di).

It is likewise possible to use blends of b).

The isocyanate prepolymer a) is based on a mono-, di- and/or polyisocyanate mixture, or a reaction product of isocyanate mixtures. Suitable compound a) are, for example, butylene 1,4-diisocyanate, hexamethylene 1,6-diisocyanate (HDI), isophorone diisocyanate (IPDI), 2,2,4- and/or 2,4,4-trimethylhexamethylene diisocyanate, the isomeric bis(4,4′-isocyanatocyclohexyl)methanes (H12-MDI) and mixtures thereof with any isomer content, cyclohexylene 1,4-diisocyanate, 4-isocyanatomethyloctane 1,8-diisocyanate (nonane triisocyanate), phenylene 1,4-diisocyanate, tolylene 2,4- and/or 2,6-diisocyanate (TDI), naphthylene 1,5-diisocyanate, diphenylmethane 2,2′- and/or 2,4′- and/or 4,4′-diisocyanate (MDI), 1,3- and/or 1,4-bis(2-isocyanatoprop-2-yl)benzene (TMXDI), 1,3-bis(isocyanatomethyl)benzene (XDI), alkyl 2,6-diisocyanatohexanoates (lysine diisocyanates) having alkyl groups having 1 to 8 carbon atoms, and mixtures thereof. Compounds comprising modifications such as allophanate, uretdione, urethane, isocyanurate, biuret, iminooxadiazinedione or oxadiazinetrione structure and based on said diisocyanates are also suitable units for component a), as also are polycyclic compounds, for example polymeric MDI (pMDI, for instance PAPI-27 from Dow or Desmodur® 44V20L products from Covestro AG or Ongronat® 2100 from Borsodchem) and combinations of the above.

Preference is given to modifications having an isocyanate (NCO) functionality of 2 to 6, preferably of 2.0 to 4.5 and more preferably of 2.0 to 4.2 and most preferably of 2.3 to 3.8. Especially preferred is an NCO functionality of 2.4 to 3.

Preference is given to modification using diisocyanates from the group of HDI, IPDI, H12-MDI, TDI and MDI. Particular preference is given to TDI and MDI, and derivatives thereof. Especially preferred MDI is polymeric MDI such as PAPI-27 used in a blend with TDI. The isocyanates are reacted with polyester-polyols based on preferred aliphatic polyester-polyols based on succinic acid, adipicacid and/or caprolactone. Preferred are polycaprolactone polyols. The polyester-polyols are further build using alcohols such as ethylenglycol, diethylenglycol, trimethylpropanol, hexandiol. The isocyanate-reactive groups have an OH number between 10 mg KOH/g and 150 mg KOH/g. Preferably the molecular weight is 300 to 750 g/mol, more preferably 300 to 500 g/mol. The functionality is from 2 to 3. Preferred is 2. If not otherwise indicated the molecular weight was determined by GPC at 20° C. with DCM as eluent and poly styrol standard.

The preferred NCO content of the NCO prepolymer is between 17% and 40% by weight, more preferably between 18% and 35% by weight, more preferably between 19% and 30% by weight and most preferably between 20% and 30% by weight. The isocyanate groups may also be present in partially or completely blocked form prior to their reaction with the isocyanate-reactive groups, in such a way that they cannot react immediately with the isocyanate-reactive group. This ensures that the reaction does not take place until a particular temperature (blocking temperature) has been reached. Typical blocking agents can be found in the prior art and are selected such that they are eliminated again from the isocyanate group at temperatures between 60 and 220° C., according to the substance, and only then react with the isocyanate-reactive group. There are blocking agents which become incorporated into the polyurethane, and there are also those which remain as solvents or plasticizers in the polyurethane or are evolved as gases from the polyurethane. The expression “blocked NCO values” is sometimes used. When the expression “NCO values” is used in the invention, this always refers to the unblocked NCO value. The usual extent of blocking is up to <0.5%.

Examples of typical blocking agents are caprolactam, methyl ethyl ketoxime, pyrazoles, for example 3,5-dimethyl-1,2-pyrazole or 1,-pyrazole, triazoles, for example 1,2,4-triazole, diisopropylamine, diethyl malonate, diethylamine, phenol and derivatives thereof, and imidazole.

Component a) may also be used in the form of a mixture of the above compounds or else of a prepolymer.

Very particular preference is given to MDI and (p)MDI as base for the NCO terminated polyester-polyol polyisocyanate prepolymer.

The invention further relates to an NCO terminated polyester-polyol polyisocyanate prepolymer, obtained by the reaction of monomeric and/or polymeric diphenylmethane 2,2′- and/or 2,4′- and/or 4,4′-diisocyanate (pMDI and/or MDI), whereas polymeric MDI is preferred and a polyester-polyol, containing at least 2 isocyanate groups and less than 3 isocyanate groups, having a NCO content >17 wt.-%, preferably 23 to 27 wt.-% and a viscosity at 30° C. according to DIN EN ISO 2884-1 of <2500 mPas, preferably 400 to 2500 mPas, more preferred 800 to 2000 mPas, and most preferred from 800 mPas to 1500 mPas, whereas preferably the polyester-polyol is a polycaprolactone ester-polyol and the polyester-polyol has a median molecular weight of 300-750 g/mol, preferably 300 to 500 g/mol.

The active ingredient c) can be dissolved in useful organic solvents d) include all customary organic solvents that on the one hand have low miscibility with water (phase separation), but on the other hand dissolve the active agrochemical ingredients used with good solubility. Preferred examples include aliphatic and aromatic, optionally halogenated hydrocarbons such as toluene, xylene, Solvesso® 100, 100ND, 150, 150 ND or 200, 200 ND (mineral oil), tetrachloromethane, chloroform, methylene chloride and dichloroethane, and also esters such as ethyl acetate, and alkanecarboxamides such as N,N-dimethyloctanamide and N,N-dimethyldecanamide. In addition come vegetable oils and modified oils (for example by methylation, ethylation and also hydrogenation and hydration) based, for example, on rapeseed oil, maize kernel oil, coconut oil or the like. Particular preference is given to using mineral oil, very particular preference to using solvents based on a from dialkylnaphthalene (for example diisopropylnaphthalene), and mixture of 1-methyl- and 2-methylnaphthalene and naphthalene (for example Solvesso® 200 ND products, CAS No.: 64742-94-5).

Moreover, if needed further additives can be added to the organic solvent d), like e.g. oilsoluble surface active ingredients. Preferred are alkyl ethoxylates, alkyl propoxy ethoxylates, sorbitan- and glycerol fatty acid esters and organo-trisoloxanes. Particularly preferred are hydroxyl-terminated alkyl ethoxylates and alkyl propoxy ethoxylates. Exemplary mentioned are Break-Thru® Vibrant, Synergen W 06, Genapol EP 2584, and Genapol X 060.

Useful protective colloids f) include all substances typically used for this purpose. Preferred examples include natural and synthetic water-soluble polymers such as gelatin, starch and cellulose derivatives, especially cellulose esters and cellulose ethers, such as methyl cellulose, and also polyvinyl alcohols, partly hydrolysed polyvinyl acetates, lignosulfonates (such as Borresperse®NA, REAX® 88 Kraftsperse® 25 S), modified naphthalenesulfonates (for instance Morwet D-425), polyvinylpyrrolidones and polyacrylamides. Particular preference is given to using polyvinyl alcohols, partly hydrolysed polyvinyl acetates and lignosulfonates. Most preferably polyvinyl alcohols and/or lignosulfonates.

Useful thickeners g) include organic thickeners and inorganic thickeners. Useful organic thickeners include organic natural or biotechnologically modified or organic synthetic thickeners. Typical synthetic thickeners are Rheostrux® (Croda) or the Thixin® or Thixatrol® series (Elementis). These are typically based on acrylates. Typical organic thickeners are based on xanthan or cellulose (for instance hydroxyethyl or carboxymethyl cellulose) or a combination thereof. Further typical representatives are based on cellulose or lignin. Preference is given to using natural modified thickeners based on xanthan. Typical representatives are, for example, Rhodopol® (Solvay) and Kelzan® (Kelco Corp.), and also Satiaxane® (Cargill). Preference is likewise given to silicas and attapulgites.

Useful preservatives g) include all substances typically present for this purpose in crop protection compositions, e.g. Dichlorophen, Benzylalkohol-hemiformal, 5-chloro-2-methyl-4-isothiazolin-3-one [CAS-No. 26172-55-4], 2-methyl-4-isothiazolin-3-one [CAS-No. 2682-20-4] or 1.2-benzisothiazol-3(2H)-one [CAS-No. 2634-33-5]. Examples include Acticide® SPX (Thor) and Proxel® GXL (Lonza).

Useful defoamers g) include all substances typically usable for this purpose in crop protection compositions. Preference is given to silane derivatives, such as polydimethylsiloxanes, and magnesium stearate. Typical products are Silcolapse® 484 (Solvay, Silioxane Emulsion) and SAG 1571 (Momentive) used.

Substances that function as cold stabilizers g) may be all of those typically usable for this purpose in crop protection compositions. Examples include urea, glycerol and propylene glycol.

The aqueous phase of the capsule suspension concentrates according to the invention may, as well as water, also comprise further additives g) such as emulsifiers, protective colloids, preservatives, defoamers, cold stabilizers, thickeners, pH stabilizers and neutralizing agents.

Useful neutralizing agents g) include customary acids and bases. Examples include phosphoric acid, citric acid, sodium hydroxide solution and aqueous ammonia solution.

The proportion of a) is generally between 0.1% and 8% by weight, preferably between 0.2% and 4.5% by weight, more preferably between 0.3% and 2.5% by weight, the proportion of active agrochemical ingredient c) is generally between 1% and 50% by weight, preferably between 5% and 40% by weight, more preferably between 10% and 20% by weight, the proportion of organic solvent d) is generally between 0% and 90% by weight, preferably between 10% and 60% by weight, more preferably between 20% and 40% by weight and most preferably between 25% and 40% by weight, the proportion of protective colloids f) is generally between 0.1% and 5% by weight, preferably between 0.2% and 3% by weight, more preferably between 0.3% and 1.5% by weight, and the proportion of additives g) is generally between 0.1% and 15% by weight, preferably between 0.3% and 10% by weight and more preferably between 0.4% and 3% by weight.

In respect of the abovementioned proportions of the respective ingredients, it will be clear to the person skilled in the art that the preferred ranges for the individual ingredients can be combined freely with one another, and so these compositions of different preferred ranges for individual ingredients are also considered to be disclosed.

However, particular preference is given, unless stated otherwise, to preferred ranges from the same level, i.e. all preferred or more preferred ranges, and a specific disclosure is not intended to replace these general combinations but to add to them.

The same applies to other specifications of preferred ranges elsewhere in the present description.

In a preferred embodiment, the proportion of a) and b) is between 0.1% and 8% by weight,

the proportion of active agrochemical ingredient c) is between 1% and 50% by weight,

the proportion of organic solvent d) is between 0% and 60% by weight,

the proportion of protective colloids f) is between 0.1% and 5% by weight,

and the proportion of additives g) is between 0.1% and 15% by weight.

In a further-preferred embodiment, the proportion of a) and b) is between 0.1% and 8% by weight,

the proportion of active agrochemical ingredient c) is between 1% and 50% by weight,

the proportion of organic solvent d) is between 0% and 40% by weight,

the proportion of protective colloids f) is between 0.1% and 5% by weight,

and the proportion of additives g) is between 0.1% and 15% by weight.

In an even further-preferred embodiment, the proportion of a) and b) is between 0.1% and 8% by weight,

the proportion of active agrochemical ingredient c) is between 1% and 50% by weight,

the proportion of organic solvent d) is between 0% and 40% by weight,

the proportion of protective colloids f) is between 0.1% and 5% by weight,

and the proportion of additives g) is between 0.1% and 15% by weight.

In a further embodiment, the proportion of a) and b) is between 0.1% and 8% by weight,

the proportion of active agrochemical ingredient c) is between 1% and 50% by weight,

the proportion of organic solvent d) is between 0% and 90% by weight,

the proportion of protective colloids f) is between 0.1% and 5% by weight,

and the proportion of additives g) is between 0.1% and 15% by weight.

In a further embodiment, the proportion of a) and b) is between 0.2% and 4.5% by weight,

the proportion of active agrochemical ingredient c) is between 5% and 40% by weight,

the proportion of organic solvent d) is between 0% and 60% by weight,

the proportion of protective colloids f) is between 0.2% and 3% by weight,

and the proportion of additives g) is between 0.2% and 10% by weight.

In a further preferred embodiment, the proportion of a) and b) is between 0.2% and 4.5% by weight,

the proportion of active agrochemical ingredient c) is between 10% and 20% by weight,

the proportion of organic solvent d) is between 0% and 40% by weight,

the proportion of protective colloids f) is between 0.3% and 1.5% by weight,

and the proportion of additives g) is between 0.2% and 3% by weight.

In a further embodiment, the proportion of a) and b) is between 0.3% and 2.5% by weight,

the proportion of active agrochemical ingredient c) is between 10% and 20% by weight,

the proportion of organic solvent d) is between 0% and 40% by weight,

the proportion of protective colloids f) is between 0.3% and 1.5% by weight,

and the proportion of additives g) is between 0.2% and 3% by weight.

In a further embodiment, the proportion of a) and b) is between 0.3% and 2.5% by weight,

the proportion of active agrochemical ingredient c) is between 10% and 20% by weight,

the proportion of organic solvent d) is between 0% and 40% by weight,

the proportion of protective colloids f) is between 0.3% and 1.5% by weight,

and the proportion of additives g) is between 0.2% and 3% by weight.

Preferably, the ratio of active agrochemical ingredient c) to the isocyanate mixture a) is between 7:1 and 40:1, preferably between 8:1 and 20:1, more preferably between 9:1 and 18:1.

The ratio of isocyanate-reactive groups b) to the isocyanate mixture c) is between 0 and 1.2, preferably between 0 and 1.1, more preferably between 0.8 and 1.1, more preferably 0.9 and 1.1 and most preferably 0.95 and 1.05.

Moreover, the organic solvent d) in the aforementioned embodiments is preferably a mineral oil, further preferably a solvent based on dialkylnaphthalene (for example diisopropylnaphthalene), or else a mixture of 1-methyl- and 2-methylnaphthalene and naphthalene (for example Solvesso® 200 ND products, CAS No.: 64742-94-5), where a as solvent a mixture of 1-methyl- and 2-methylnaphthalene and naphthalene is very particularly preferred. If the active ingredient c) is liquid at room temperature, preferably no solvent as e.g. in the case of Clomazone or Acetochlor is used. In a preferred embodiment, the active ingredient can act as a solvent d) for a further active

The active compounds identified here by their common names are known and are described, for example, in the pesticide handbook (“The Pesticide Manual” 16th Ed., British Crop Protection Council 2012) or can be found on the Internet (e.g. http://www.alanwood.net/pesticides). The classification is based on the current FRAC, HRAC, IRAC Mode of Action Classification Scheme at the time of filing of this patent application.

Preferred active herbicidal ingredients c) are aclonifen, aminopyralid, benzofenap, bifenox, bromoxynil, bromoxynil butyrate, potassium heptanoate and octanoate, butachlor, bixlozone, clomazone, clopyralid, 2,4-D also comprising the following frequently used forms: 2,4-D-butotyl, 2,4-D-butyl, 2,4-D-dimethylammonium, 2,4-D-diolamine (2,4-D-diethanolammonium), 2,4-D-ethyl, 2,4-D-2-ethylhexyl, 2,4-D-isobutyl, 2,4-D-isooctyl, 2,4-D-isopropyl, 2,4-D-isopropylammonium, 2,4-D-sodium, 2,4-D-triisopropanolammonium, 2,4-D-trolamine (2,4-D-triethanolammonium, diflufenican, 2[(2,4-dichlorophenyl)methyl]-4,4′-dimethyl-3-isoxazolidinone (CAS Number 81777-95-9 or IPUAC 2-(2,4-dichlorobenzyl)-4,4-dimethyl-1,2-oxazolidin-3-one, Cinmethylin, dimethachlor, dimethenamid, dimethenamid-P, ethoxysulfuron, fenoxaprop, fenoxaprop-P, penoxaprop-ethyl, fenoxaprop-P-ethyl, fenquinotrione, fentrazamide, florasulam, flufenacet, fluroxypyr, fluroxypyr-meptyl, foramsulfuron, halauxifen-methyl, iodosulfuron iodosulfuron-methyl-sodium, isoxaflutole, MCPA (4-chloro-2-methylphenoxy)acetic acid, also comprising the following frequently used forms: MCPA-butotyl, MCPA-dimethylammonium, MCPA-isoctyl, MCPA-sodium, MCPA-potassium, MCPA-2-ethylhexyl, mefenacet, mesosulfuron, mesosulfuron-methyl, metazachlor, metolachlor, S-metolachlor, metosulam, metribuzin, napropamid, nicosulfuron, oxadiargyl, oxadiazon, pendimethalin, pethoxamid, picloram, propoxycarbazone, propoxycarbazone-sodium, propyzamid, prosulfocarb, pyrasulfotole, pyroxasulfone, pyroxsulam, quinmerac, tefuryltrione, tembotrione, thiencarbazone, thiencarbazone-methyl, triafamone.

Preferred safeners which shall be included in compounds c are the following safeners named component s):
s1) Compounds from the group of heterocyclic carboxylic acid derivatives:
   s1^{a}) Compounds of the dichlorophenylpyrazoline-3-carboxylic acid type (S1^{a}), preferably compounds such as 1-(2,4-dichlorophenyl)-5-(ethoxycarbonyl)-5-methyl-2-pyrazoline-3-carboxylic acid, ethyl 1-(2,4-dichlorophenyl)-5-(ethoxycarbonyl)-5-methyl-2-pyrazoline-3-carboxylate (S1-1) (“mefenpyr-diethyl”), and related compounds as described in WO-A-91/07874;
s1^{b}) Derivatives of dichlorophenylpyrazolecarboxylic acid (S1^{b}), preferably compounds such as ethyl 1-(2,4-dichlorophenyl)-5-methylpyrazole-3-carboxylate (S1-2), ethyl 1-(2,4-dichlorophenyl)-5-isopropylpyrazole-3-carboxylate (S1-3), ethyl 1-(2,4-dichlorophenyl)-5-(1,1-dimethylethyl)pyrazole-3-carboxylate (S1-4) and related compounds as described in EP-A-333 131 and EP-A-269 806;
s1^{c}) Derivatives of 1,5-diphenylpyrazole-3-carboxylic acid (S1^{c}), preferably compounds such as ethyl 1-(2,4-dichlorophenyl)-5-phenylpyrazole-3-carboxylate (S1-5), methyl 1-(2-chlorophenyl)-5-phenylpyrazole-3-carboxylate (S1-6) and related compounds as described, for example, in EP-A-268554;
s1^{d}) Compounds of the triazolecarboxylic acid type (S1^{d}), preferably compounds such as fenchlorazole (ethyl ester), i.e. ethyl 1-(2,4-dichlorophenyl)-5-trichloromethyl-(1H)-1,2,4-triazole-3-carboxylate (S1-7), and related compounds, as described in EP-A-174 562 and EP-A-346 620;
s1^{e}) Compounds of the 5-benzyl- or 5-phenyl-2-isoxazoline-3-carboxylic acid or of the 5,5-diphenyl-2-isoxazoline-3-carboxylic acid type (S1^{e}), preferably compounds such as ethyl 5-(2,4-dichlorobenzyl)-2-isoxazoline-3-carboxylate (S1-8) or ethyl 5-phenyl-2-isoxazoline-3-carboxylate (S1-9) and related compounds as described in WO-A-91/08202, or 5,5-diphenyl-2-isoxazolinecarboxylic acid (S1-10) or ethyl 5,5-diphenyl-2-isoxazoline-3-carboxylate (S1-11) (“isoxadifen-ethyl”) or n-propyl 5,5-diphenyl-2-isoxazoline-3-carboxylate (S1-12) or ethyl 5-(4-fluorophenyl)-5-phenyl-2-isoxazoline-3-carboxylate (S1-13), as described in patent application WO-A-95/07897.
s2) Compounds from the group of the 8-quinolinoxy derivatives (S2):
s2^{a}) Compounds of the 8-quinolinoxyacetic acid type (S2^{a}), preferably 1-methylhexyl (5-chloro-8-quinolinoxy)acetate (“cloquintocet-mexyl”) (S2-1), 1,3-dimethylbut-1-yl (5-chloro-8-quinolinoxy)acetate (S2-2), 4-allyloxybutyl (5-chloro-8-quinolinoxy)acetate (S2-3), 1-allyloxyprop-2-yl (5-chloro-8-quinolinoxy)acetate (S2-4), ethyl (5-chloro-8-quinolinoxy)acetate (S2-5), methyl 5-chloro-8-quinolinoxyacetate (S2-6), allyl (5-chloro-8-quinolinoxy)acetate (S2-7), 2-(2-propylideneiminoxy)-1-ethyl (5-chloro-8-quinolinoxy)acetate (S2-8), 2-oxoprop-1-yl (5-chloro-8-quinolinoxy)acetate (S2-9) and related compounds, as described in EP-A-86 750, EP-A-94 349 and EP-A-191 736 or EP-A-0 492 366, and also (5-chloro-8-quinolinoxy)acetic acid (S2-10), hydrates and salts thereof, for example the lithium, sodium, potassium, calcium, magnesium, aluminium, iron, ammonium, quaternary ammonium, sulfonium or phosphonium salts thereof, as described in WO-A-2002/34048;
s2^{b}) Compounds of the (5-chloro-8-quinolinoxy)malonic acid type (S2^{b}), preferably compounds such as diethyl (5-chloro-8-quinolinoxy)malonate, diallyl (5-chloro-8-quinolinoxy)malonate, methyl ethyl (5-chloro-8-quinolinoxy)malonate and related compounds, as described in EP-A-0 582 198.
s3) Active ingredients of the dichloroacetamide type (S3), which are frequently used as pre-emergence safeners (soil-acting safeners), for example
“dichlormid” (N,N-diallyl-2,2-dichloroacetamide) (S3-1),
“R-29148” (3-dichloroacetyl-2,2,5-trimethyl-1,3-oxazolidine) from Stauffer (S3-2),
“R-28725” (3-dichloroacetyl-2,2-dimethyl-1,3-oxazolidine) from Stauffer (S3-3),
“benoxacor” (4-dichloroacetyl-3,4-dihydro-3-methyl-2H-1,4-benzoxazine) (S3-4),
“PPG-1292” (N-allyl-N-[(1,3-dioxolan-2-yl)methyl]dichloroacetamide) from PPG Industries (S3-5),
“DKA-24” (N-allyl-N-[(allylaminocarbonyl)methyl]dichloroacetamide) from Sagro-Chem (S3-6),
“AD-67” or “MON 4660” (3-dichloroacetyl-1-oxa-3-azaspiro[4.5]decane) from Nitrokemia or Monsanto (53-7),
“TI-35” (1-dichloroacetylazepane) from TRI-Chemical RT (S3-8),
“Diclonon” (Dicyclonon) or “BAS145138” or “LAB145138” (S3-9)
((RS)-1-dichloroacetyl-3,3,8a-trimethylperhydropyrrolo[1,2-a]pyrimidin-6-one) from BASF,
“furilazole” or “MON 13900” ((RS)-3-dichloroacetyl-5-(2-furyl)-2,2-dimethyloxazolidine) (S3-10), and the (R) isomer thereof (S3-11).
s4) Compounds from the class of the acylsulfonamides (S4):
s4^{a}) N-Acylsulfonamides of the formula (S4^{a}) and salts thereof, as described in WO-A-97/45016,

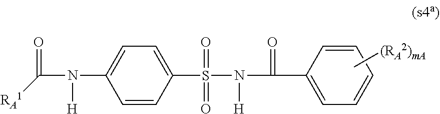

in which

R_{A}¹ is (C₁-C₆alkyl, (C₃-C₆)cycloalkyl, cycloalkyl, where the 2 latter radicals are substituted by v_{A} substituents from the group of halogen, (C₁-C₄)alkoxy, (C₁-C₆)haloalkoxy and (C₁-C₄)alkylthio and, in the case of cyclic radicals, also by (C₁-C₄)alkyl and (C₁-C₄)haloalkyl;

R_{A}² is halogen, (C₁-C₄)alkyl, (C₁-C₄)alkoxy, CF₃;

m_{A} is 1 or 2;

v_{A} is 0, 1, 2 or 3;
s4^{b}) Compounds of the 4-(benzoylsulfamoyl)benzamide type of the formula (S4^{b}) and salts thereof, as described in WO-A-99/16744,

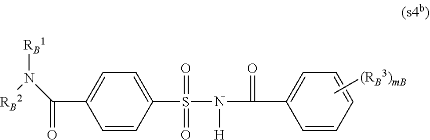

in which
R_{B}¹, R_{B}² are independently hydrogen, (C₁-C₆)alkyl, (C₃-C₆)cycloalkyl, (C₃-C₆)alkenyl, (C₃-C₆)alkynyl,
R_{B}³ is halogen, (C₁-C₄)alkyl, (C₁-C₄)haloalkyl or (C₁-C₄)alkoxy and
m_{B} is 1 or 2,
for example those in which
R_{B}¹=cyclopropyl, R_{B}²=hydrogen and (R_{B}³)=2-OMe (“cyprosulfamide”, S4-1),
R_{B}¹=cyclopropyl, R_{B}²=hydrogen and (R_{B}³)=5-Cl-2-OMe (S4-2),
R_{B}¹=ethyl, R_{B}²=hydrogen and (R_{B}³)=2-OMe (S4-3),
R_{B}¹=isopropyl, R_{B}²=hydrogen and (R_{B}³)=5-Cl-2-OMe (S4-4) and
R_{B}¹=isopropyl, R_{B}²=hydrogen and (R_{B}³)=2-OMe (S4-5);
s4^{c}) Compounds from the class of the benzoylsulfamoylphenylureas of the formula (S4^{c}), as described in EP-A-365484,

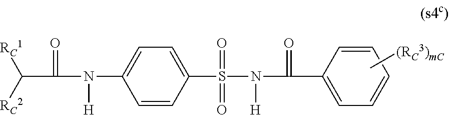

in which
R_{C}¹, R_{C}² are independently hydrogen, (C₁-C₈)alkyl, (C₃-C₈)cycloalkyl, (C₃-C₆)alkenyl, (C₃-C₆)alkynyl,
R_{C}³ is halogen, (C₁-C₄)alkyl, (C₁-C₄)alkoxy, CF₃ and
m_{C} is 1 or 2;
for example
1-[4-(N-2-methoxybenzoylsulfamoyl)phenyl]-3-methylurea,
1-[4-(N-2-methoxybenzoylsulfamoyl)phenyl]-3,3-dimethylurea,
1-[4-(N-4,5-dimethylbenzoylsulfamoyl)phenyl]-3-methylurea;
s4^{d}) Compounds of the N-phenylsulfonylterephthalamide type of the formula (S4^{d}) and salts thereof, which are known, for example, from CN 101838227,

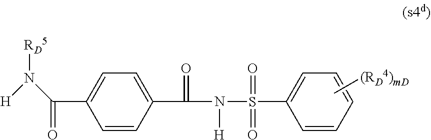

in which
R_{D}⁴ is halogen, (C₁-C₄)-alkyl, (C₁-C₄)-alkoxy, CF₃;
m_{D} is 1 or 2;
R_{D}⁵ is hydrogen, (C₁-C₆)-alkyl, (C₃-C₆)-cycloalkyl, (C₂-C₆)-alkenyl, (C₂-C₆)-alkynyl or (C₅-C₆)-cycloalkenyl.
s5) Active ingredients from the class of the hydroxyaromatics and the aromatic-aliphatic carboxylic acid derivatives (S5), for example ethyl 3,4,5-triacetoxybenzoate, 3,5-dimethoxy-4-hydroxybenzoic acid, 3,5-dihydroxybenzoic acid, 4-hydroxysalicylic acid, 4-fluorosalicyclic acid, 2-hydroxycinnamic acid, 2,4-dichlorocinnamic acid, as described in WO-A-2004/084631, WO-A-2005/015994, WO-A-2005/016001.
s6) Active ingredients from the class of the 1,2-dihydroquinoxalin-2-ones (S6), for example 1-methyl-3-(2-thienyl)-1,2-dihydroquinoxalin-2-one, 1-methyl-3-(2-thienyl)-1,2-dihydroquinoxaline-2-thione, 1-(2-aminoethyl)-3-(2-thienyl)-1,2-dihydroquinoxalin-2-one hydrochloride, 1-(2-methylsulfonylaminoethyl)-3-(2-thienyl)-1,2-dihydroquinoxalin-2-one, as described in WO-A-2005/112630.
s7) Compounds from the class of the diphenylmethoxyacetic acid derivatives (S7), for example methyl diphenylmethoxyacetate (CAS Reg. No. 41858-19-9) (57-1), ethyl diphenylmethoxyacetate or diphenylmethoxyacetic acid, as described in WO-A-98/38856.
s8) Compounds of the formula (S8), as described in WO-A-98/27049,

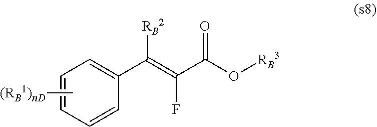

in which the symbols and indices are defined as follows:
R_{D}¹ is halogen, (C₁-C₄)-alkyl, (C₁-C₄)-haloalkyl, (C₁-C₄)-alkoxy, (C₁-C₄)-haloalkoxy,
R_{D}² is hydrogen or (C₁-C₄)-alkyl,
R_{D}³ is hydrogen, (C₁-C₈)-alkyl, (C₂-C₄)-alkenyl, (C₂-C₄)-alkynyl or aryl, where each of the aforementioned carbon-containing radicals is unsubstituted or substituted by one or more, preferably up to three identical or different radicals from the group consisting of halogen and alkoxy; or salts thereof,
n_{D} is an integer from 0 to 2.
s9) Active ingredients from the class of the 3-(5-tetrazolylcarbonyl)-2-quinolones (S9), for example 1,2-dihydro-4-hydroxy-1-ethyl-3-(5-tetrazolylcarbonyl)-2-quinolone (CAS Reg. No.: 219479-18-2), 1,2-dihydro-4-hydroxy-1-methyl-3-(5-tetrazolylcarbonyl)-2-quinolone (CAS Reg. No. 95855-00-8), as described in WO-A-1999/000020.
s10) Compounds of the formula (S10^{a}) or (S10^{b})
   as described in WO-A-2007/023719 and WO-A-2007/023764,

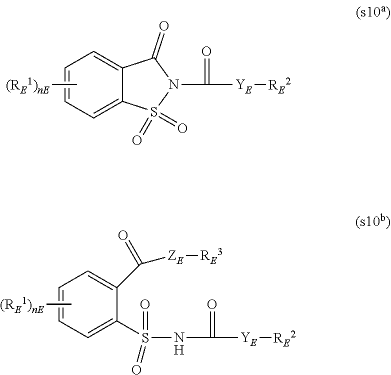

in which
R_{E}¹ is halogen, (C₁-C₄)-alkyl, methoxy, nitro, cyano, CF₃, OCF₃
Y_{E}, Z_{E} are independently O or S,
n_{E} is an integer from 0 to 4,
R_{E}² is (C₁-C₁₆)-alkyl, (C₂-C₆)-alkenyl, (C₃-C₆)-cycloalkyl, aryl; benzyl, halobenzyl,
R_{E}³ is hydrogen or (C₁-C₆)-alkyl.
s11) Active ingredients of the oxyimino compound type (S11), which are known as seed-dressing agents, for example
   “oxabetrinil” ((Z)-1,3-dioxolan-2-ylmethoxyimino(phenyl)acetonitrile) (S11-1), which is known as a seed-dressing safener for millet/sorghum against metolachlor damage,
   “fluxofenim” (1-(4-chlorophenyl)-2,2,2-trifluoro-1-ethanone 0-(1,3-dioxolan-2-ylmethyl)oxime) (S11-2), which is known as a seed-dressing safener for millet/sorghum against metolachlor damage, and
   “cyometrinil” or “CGA-43089” ((Z)-cyanomethoxyimino(phenyl)acetonitrile) (S11-3), which is known as a seed-dressing safener for millet/sorghum against metolachlor damage.
s12) Active ingredients from the class of the isothiochromanones (S12), for example methyl [(3-oxo-1H-2-benzothiopyran-4(3H)-ylidene)methoxy]acetate (CAS Reg. No. 205121-04-6) (S12-1) and related compounds from WO-A-1998/13361.
s13) One or more compounds from group (S13):
   “naphthalic anhydride” (1,8-naphthalenedicarboxylic anhydride) (S13-1), which is known as a seed-dressing safener for corn against thiocarbamate herbicide damage,
   “fenclorim” (4,6-dichloro-2-phenylpyrimidine) (S13-2), which is known as a safener for pretilachlor in sown rice,
   “flurazole” (benzyl 2-chloro-4-trifluoromethyl-1,3-thiazole-5-carboxylate) (S13-3), which is known as a seed-dressing safener for millet/sorghum against alachlor and metolachlor damage,
   “CL 304415” (CAS Reg. No. 31541-57-8)
   (4-carboxy-3,4-dihydro-2H-1-benzopyran-4-acetic acid) (S13-4) from American Cyanamid, which is known as a safener for corn against damage by imidazolinones,
   “MG 191” (CAS Reg. No. 96420-72-3) (2-dichloromethyl-2-methyl-1,3-dioxolane) (S13-5) from Nitrokemia, which is known as a safener for corn,
   “MG 838” (CAS Reg. No. 133993-74-5)
   (2-propenyl 1-oxa-4-azaspiro[4.5]decane-4-carbodithioate) (S13-6) from Nitrokemia
   “disulfoton” (0,0-diethyl S-2-ethylthioethyl phosphorodithioate) (S13-7),
   “dietholate” (0,0-diethyl 0-phenyl phosphorothioate) (S13-8),
   “mephenate” (4-chlorophenyl methylcarbamate) (S13-9).
s14) Active ingredients which, in addition to herbicidal action against weeds, also have safener action on crop plants such as rice, for example
   “dimepiperate” or “MY-93” (S-1-methyl 1-phenylethylpiperidine-1-carbothioate), which is known as a safener for rice against damage by the herbicide molinate,
   “daimuron” or “SK 23” (1-(1-methyl-1-phenylethyl)-3-p-tolylurea), which is known as safener for rice against imazosulfuron herbicide damage,
   “cumyluron”=“JC-940” (3-(2-chlorophenylmethyl)-1-(1-methyl-1-phenylethyl)urea, see JP-A-60087254), which is known as safener for rice against damage by some herbicides,
   “methoxyphenone” or “NK 049” (3,3′-dimethyl-4-methoxybenzophenone), which is known as a safener for rice against damage by some herbicides,
   “CSB” (1-bromo-4-(chloromethylsulfonyl)benzene) from Kumiai, (CAS Reg. No. 54091-06-4), which is known as a safener against damage by some herbicides in rice.
s15) Compounds of the formula (S15) or tautomers thereof

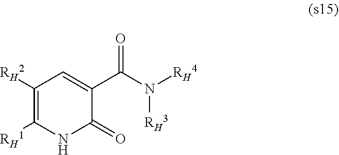

as described in WO-A-2008/131861 and WO-A-2008/131860
in which
R_{H}¹ is a (C₁-C₆)-haloalkyl radical and
R_{H}² is hydrogen or halogen and
R_{H}³, R_{H}⁴ are each independently hydrogen, (C₁-C₁₆)-alkyl, (C₂-C₁₆)-alkenyl or (C₂-C₁₆)-alkynyl,
   where each of the 3 latter radicals is unsubstituted or substituted by one or more radicals from the group of halogen, hydroxyl, cyano, (C₁-C₄)-alkoxy, (C₁-C₄)-haloalkoxy, (C₁-C₄)-alkylthio, (C₁-C₄)-alkylamino, di[(C₁-C₄)-alkyl]amino, [(C₁-C₄)-alkoxy]carbonyl, [(C₁-C₄)-haloalkoxy]carbonyl, (C₃-C₆)-cycloalkyl which is unsubstituted or substituted, phenyl which is unsubstituted or substituted, and heterocyclyl which is unsubstituted or substituted,
or (C₃-C₆)-cycloalkyl, (C₄-C₆)-cycloalkenyl, (C₃-C₆)-cycloalkyl fused on one side of the ring to a 4 to 6-membered saturated or unsaturated carbocyclic ring, or (C₄-C₆)-cycloalkenyl fused on one side of the ring to a 4 to 6-membered saturated or unsaturated carbocyclic ring,
   where each of the 4 latter radicals is unsubstituted or substituted by one or more radicals from the group of halogen, hydroxyl, cyano, (C₁-C₄)alkyl, (C₁-C₄)haloalkyl, (C₁-C₄)alkoxy, (C₁-C₄)haloalkoxy, (C₁-C₄)alkylthio, (C₁-C₄)alkylamino, di[(C₁-C₄)alkyl]amino, [(C₁-C₄)alkoxy]carbonyl, [(C₁-C₄)haloalkoxy]carbonyl, (C₃-C₆)cycloalkyl which is unsubstituted or substituted, phenyl which is unsubstituted or substituted, and heterocyclyl which is unsubstituted or substituted,
or
R_{H}³ is (C₁-C₄)-alkoxy, (C₂-C₄)-alkenyloxy, (C₂-C₆)-alkynyloxy or (C₂-C₄)-haloalkoxy and
R_{H}⁴ is hydrogen or (C₁-C₄)-alkyl or
R_{H}³ and R_{H}⁴ together with the directly bonded nitrogen atom are a four- to eight-membered heterocyclic ring which, as well as the nitrogen atom, may also contain further ring heteroatoms, preferably up to two further ring heteroatoms from the group of N, O and S, and which is unsubstituted or substituted by one or more radicals from the group of halogen, cyano, nitro, (C₁-C₄)alkyl, (C₁-C₄)haloalkyl, (C₁-C₄)alkoxy, (C₁-C₄)haloalkoxy and (C₁-C₄)alkylthio.
s16) Active ingredients which are used primarily as herbicides but also have safener action on crop plants, for example
(2,4-dichlorophenoxy)acetic acid (2,4-D),
(4-chlorophenoxy)acetic acid,
(R,S)-2-(4-chloro-o-tolyloxy)propionic acid (mecoprop),
4-(2,4-dichlorophenoxy)butyric acid (2,4-DB),
(4-chloro-o-tolyloxy)acetic acid (MCPA),
4-(4-chloro-o-tolyloxy)butyric acid,
4-(4-chlorophenoxy)butyric acid,
3,6-dichloro-2-methoxybenzoic acid (dicamba),
1-(ethoxycarbonyl)ethyl 3,6-dichloro-2-methoxybenzoate (lactidichlor-ethyl).

Preferred safeners s) are selected from the group of isoxadifen-ethyl, cyprosulfamide, cloquintocet-mexyl and mefenpyr-diethyl. Particular preference is given to mefenpyr-diethyl and cloquintocet-mexyl. Very particular preference is given to mefenpyr-diethyl.

Particular preference is given to active herbicidal ingredients c) selected from the group of:

flufenacet, prosulfocarb, pendimethalin, diflufenican, aclonifen, metribuzin, pyroxasulfone, propoxycarbazone, thiencarbazone-methyl, fenoxaprop, bromoxynil, halauxifen-methyl, 2,4-D, MCPA.

Very particular preference is given to the active herbicidal ingredients c) flufenacet, pyroxasulfone, diflufenican.

Particular preference is also given to mixtures of one or more active herbicidal ingredients c) selected from the group of:

flufenacet and pethoxamid; flufenacet and aclonifen; flufenacet and metribuzin; flufenacet and halauxifen-methyl; prosulfocarb and diflufenican; prosulfocarb and aclonifen; prosulfocarb and metribuzin; prosulfocarb and flufenacet; prosulfocarb and halauxifen-methyl; pendimethalin and diflufenican; pendimethalin and aclonifen; pendimethalin and metribuzin; pendimethalin and halauxifen-methyl; metribuzin and diflufenican; halauxifen-methyl and diflufenican; flufenacet and diflufenican; metribuzin and aclonifen, halauxifen-methyl and aclonifen; pyroxasulfone and diflufenican; aclonifen and diflufenican; pyroxasulfone and prosulfocarb; pyroxasulfone and aclonifen; pyroxasulfone and metribuzin; pyroxasulfone and flufenacet; pyroxasulfone and halauxifen-methyl or flufenacet and pyroxasulfone and dilflufenican; aclonifen and diflufenican and flufenacet; metribuzin and diflufenican and flufenacet.

The mixtures are most preferably selected from: flufenacet and diflufenican; flufenacet and pyroxasulfone; aclonifen and diflufenican; metribuzin and diflufenican; flufenacet and aclonifen; flufenacet and metribuzin; flufenacet and pyroxasulfone and dilflufenican; aclonifen and diflufenican and flufenacet; metribuzin and diflufenican and flufenacet.

The active herbicidal ingredients c) mentioned and mixtures thereof may likewise be used with a safener s) selected from the group of isoxadifen-ethyl, cyprosulfamide, cloquintocet-mexyl and mefenpyr-diethyl.

Most preferably, the mixtures comprising c) and s) are selected from: 2-[(2,4-dichlorophenyl)methyl]-4,4′-dimethyl-3-isoxazolidinone (CAS Number 81777-95-9 or IPUAC 2-(2,4-dichlorobenzyl)-4,4-dimethyl-1,2-oxazolidin-3-one, Cinmethylin, flufenacet and diflufenican and mefenpyr-diethyl; flufenacet and diflufenican and cloquintocet-mexyl, aclonifen and diflufenican and mefenpyr-diethyl; pyroxasulfone and mefenpyr-diethyl.

Examples of fungicides as compound c) are:

1) Inhibitors of the ergosterol biosynthesis, for example (1.001) cyproconazole, (1.002) difenoconazole, (1.003) epoxiconazole, (1.004) fenhexamid, (1.005) fenpropidin, (1.006) fenpropimorph, (1.007) fenpyrazamine, (1.008) fluquinconazole, (1.009) flutriafol, (1.010) imazalil, (1.011) imazalil sulfate, (1.012) ipconazole, (1.013) metconazole, (1.014) myclobutanil, (1.015) paclobutrazol, (1.016) prochloraz, (1.017) propiconazole, (1.018) prothioconazole, (1.019) pyrisoxazole, (1.020) spiroxamine, (1.021) tebuconazole, (1.022) tetraconazole, (1.023) triadimenol, (1.024) tridemorph, (1.025) triticonazole, (1.026) (1R,2S,5S)-5-(4-chlorobenzyl)-2-(chloromethyl)-2-methyl-1-(1H-1,2,4-triazol-1-ylmethyl)cyclopentanol, (1.027) (1S,2R,5R)-5-(4-chlorobenzyl)-2-(chloromethyl)-2-methyl-1-(1H-1,2,4-triazol-1-ylmethyl)cyclopentanol, (1.028) (2R)-2-(1-chlorocyclopropyl)-4-[(1R)-2,2-dichlorocyclopropyl]-1-(1H-1,2,4-triazol-1-yl)butan-2-ol, (1.029) (2R)-2-(1-chlorocyclopropyl)-4-[(1S)-2,2-dichlorocyclopropyl]-1-(1H-1,2,4-triazol-1-yl)butan-2-ol, (1.030) (2R)-2-[4-(4-chlorophenoxy)-2-(trifluoromethyl)phenyl]-1-(1H-1,2,4-triazol-1-yl)propan-2-ol, (1.031) (2S)-2-(1-chlorocyclopropyl)-4-[(1R)-2,2-dichlorocyclopropyl]-1-(1H-1,2,4-triazol-1-yl)butan-2-ol, (1.032) (2S)-2-(1-chlorocyclopropyl)-4-[(1S)-2,2-dichlorocyclopropyl]-1-(1H-1,2,4-triazol-1-yl)butan-2-ol, (1.033) (2S)-2-[4-(4-chlorophenoxy)-2-(trifluoromethyl)phenyl]-1-(1H-1,2,4-triazol-1-yl)propan-2-ol, (1.034) (R)-[3-(4-chloro-2-fluorophenyl)-5-(2,4-difluorophenyl)-1,2-oxazol-4-yl](pyridin-3-yl)methanol, (1.035) (S)-[3-(4-chloro-2-fluorophenyl)-5-(2,4-difluorophenyl)-1,2-oxazol-4-yl](pyridin-3-yl)methanol, (1.036) [3-(4-chloro-2-fluorophenyl)-5-(2,4-difluorophenyl)-1,2-oxazol-4-yl](pyridin-3-yl)methanol, (1.037) 1-({(2R,4S)-2-[2-chloro-4-(4-chlorophenoxy)phenyl]-4-methyl-1,3-dioxolan-2-yl}methyl)-1H-1,2,4-triazole, (1.038) 1-({(2S,4S)-2-[2-chloro-4-(4-chlorophenoxy)phenyl]-4-methyl-1,3-dioxolan-2-yl}methyl)-1H-1,2,4-triazole, (1.039) 1-{[3-(2-chlorophenyl)-2-(2,4-difluorophenyl)oxiran-2-yl]methyl}-1H-1,2,4-triazol-5-yl thiocyanate, (1.040) 1-{[rel(2R,3R)-3-(2-chlorophenyl)-2-(2,4-difluorophenyl)oxiran-2-yl]methyl}-1H-1,2,4-triazol-5-yl thiocyanate, (1.041) 1-{[rel(2R,3S)-3-(2-chlorophenyl)-2-(2,4-difluorophenyl)oxiran-2-yl]methyl}-1H-1,2,4-triazol-5-yl thiocyanate, (1.042) 2-[(2R,4R,5R)-1-(2,4-dichlorophenyl)-5-hydroxy-2,6,6-trimethylheptan-4-yl]-2,4-dihydro-3H-1,2,4-triazole-3-thione, (1.043) 2-[(2R,4R,5S)-1-(2,4-dichlorophenyl)-5-hydroxy-2,6,6-trimethylheptan-4-yl]-2,4-dihydro-3H-1,2,4-triazole-3-thione, (1.044) 2-[(2R,4S,5R)-1-(2,4-dichlorophenyl)-5-hydroxy-2,6,6-trimethylheptan-4-yl]-2,4-dihydro-3H-1,2,4-triazole-3-thione, (1.045) 2-[(2R,4S,5S)-1-(2,4-dichloro-phenyl)-5-hydroxy-2,6,6-trimethylheptan-4-yl]-2,4-dihydro-3H-1,2,4-triazole-3-thione, (1.046) 2-[(2S,4R,5R)-1-(2,4-dichlorophenyl)-5-hydroxy-2,6,6-trimethylheptan-4-yl]-2,4-dihydro-3H-1,2,4-triazole-3-thione, (1.047) 2-[(2S,4R,5S)-1-(2,4-dichlorophenyl)-5-hydroxy-2,6,6-trimethylheptan-4-yl]-2,4-dihydro-3H-1,2,4-triazole-3-thione, (1.048) 2-[(2S,4S,5R)-1-(2,4-dichlorophenyl)-5-hydroxy-2,6,6-trimethylheptan-4-yl]-2,4-dihydro-3H-1,2,4-triazole-3-thione, (1.049) 2-[(2S,4S,5S)-1-(2,4-dichlorophenyl)-5-hydroxy-2,6,6-trimethylheptan-4-yl]-2,4-dihydro-3H-1,2,4-triazole-3-thione, (1.050) 2-[1-(2,4-dichlorophenyl)-5-hydroxy-2,6,6-trimethylheptan-4-yl]-2,4-dihydro-3H-1,2,4-triazole-3-thione, (1.051) 2-[2-chloro-4-(2,4-dichlorophenoxy)phenyl]-1-(1H-1,2,4-triazol-1-yl)propan-2-ol, (1.052) 2-[2-chloro-4-(4-chlorophenoxy)phenyl]-1-(1H-1,2,4-triazol-1-yl)butan-2-ol, (1.053) 2-[4-(4-chlorophenoxy)-2-(trifluoromethyl)phenyl]-1-(1H-1,2,4-triazol-1-yl)butan-2-ol, (1.054) 2-[4-(4-chlorophenoxy)-2-(trifluoromethyl)phenyl]-1-(1H-1,2,4-triazol-1-yl)pentan-2-ol, (1.055) Mefentrifluconazole, (1.056) 2-{[3-(2-chlorophenyl)-2-(2,4-difluorophenyl)oxiran-2-yl]methyl}-2,4-dihydro-3H-1,2,4-triazole-3-thione, (1.057) 2-{[rel(2R,3R)-3-(2-chlorophenyl)-2-(2,4-difluorophenyl)oxiran-2-yl]methyl}-2,4-dihydro-3H-1,2,4-triazole-3-thione, (1.058) 2-{[rel(2R,3S)-3-(2-chlorophenyl)-2-(2,4-difluorophenyl)oxiran-2-yl]methyl}-2,4-dihydro-3H-1,2,4-triazole-3-thione, (1.059) 5-(4-chlorobenzyl)-2-(chloromethyl)-2-methyl-1-(1H-1,2,4-triazol-1-ylmethyl)cyclopentanol, (1.060) 5-(allylsulfanyl)-1-{[3-(2-chlorophenyl)-2-(2,4-difluorophenyl)oxiran-2-yl]methyl}-1H-1,2,4-triazole, (1.061) 5-(allylsulfanyl)-1-{[rel(2R,3R)-3-(2-chlorophenyl)-2-(2,4-difluorophenyl)oxiran-2-yl]methyl}-1H-1,2,4-triazole, (1.062) 5-(allylsulfanyl)-1-{[rel(2R,3S)-3-(2-chlorophenyl)-2-(2,4-difluorophenyl)oxiran-2-yl]methyl}-1H-1,2,4-triazole, (1.063) N′-(2,5-dimethyl-4-{[3-(1,1,2,2-tetrafluoroethoxy)phenyl]sulfanyl}phenyl)-N-ethyl-N-methylimidoformamide, (1.064) N′-(2,5-dimethyl-4-{[3-(2,2,2-trifluoroethoxy)phenyl]sulfanyl}phenyl)-N-ethyl-N-methylimidoformamide, (1.065) N′-(2,5-dimethyl-4-{[3-(2,2,3,3-tetrafluoropropoxy)phenyl]sulfanyl}phenyl)-N-ethyl-N-methylimidoformamide, (1.066) N′-(2,5-dimethyl-4-{[3-(pentafluoroethoxy)phenyl]sulfanyl}phenyl)-N-ethyl-N-methylimidoformamide, (1.067) N′-(2,5-dimethyl-4-{3-[(1,1,2,2-tetrafluoroethyl)sulfanyl]phenoxy}phenyl)-N-ethyl-N-methylimidoformamide, (1.068) N′-(2,5-dimethyl-4-{3-[(2,2,2-trifluoroethyl)sulfanyl]phenoxy}phenyl)-N-ethyl-N-methylimidoformamide, (1.069) N′-(2,5-dimethyl-4-{3-[(2,2,3,3-tetrafluoropropyl)sulfanyl]-phenoxy}phenyl)-N-ethyl-N-methylimidoformamide, (1.070) N′-(2,5-dimethyl-4-{3-[(pentafluoro-ethyl)sulfanyl]phenoxy}phenyl)-N-ethyl-N-methylimidoformamide, (1.071) N′-(2,5-dimethyl-4-phenoxyphenyl)-N-ethyl-N-methylimidoformamide, (1.072) N′-(4-{[3-(difluoromethoxy)phenyl]sulfanyl}-2,5-dimethylphenyl)-N-ethyl-N-methylimidoformamide, (1.073) N′-(4-{3-[(difluoro-methyl)sulfanyl]phenoxy}-2,5-dimethylphenyl)-N-ethyl-N-methylimidoformamide, (1.074) N′-[5-bromo-6-(2,3-dihydro-1H-inden-2-yloxy)-2-methylpyridin-3-yl]-N-ethyl-N-methylimidoformamide, (1.075) N′-{4-[(4,5-dichloro-1,3-thiazol-2-yl)oxy]-2,5-dimethylphenyl}-N-ethyl-N-methylimidoformamide, (1.076) N′-{5-bromo-6-[(1R)-1-(3,5-difluorophenyl)ethoxy]-2-methylpyridin-3-yl}-N-ethyl-N-methylimidoformamide, (1.077) N′-{5-bromo-6-[(1S)-1-(3,5-difluorophenyl)ethoxy]-2-methylpyridin-3-yl}-N-ethyl-N-methylimidoformamide, (1.078) N′-{5-bromo-6-[(cis-4-isopropylcyclohexyl)oxy]-2-methylpyridin-3-yl}-N-ethyl-N-methylimidoformamide, (1.079) N′-{5-bromo-6-[(trans-4-isopropyl-cyclohexyl)oxy]-2-methylpyridin-3-yl}-N-ethyl-N-methylimidoformamide, (1.080) N′-{5-bromo-6-[1-(3,5-difluorophenyl)ethoxy]-2-methylpyridin-3-yl}-N-ethyl-N-methylimidoformamide, (1.081) ipfentrifluconazole, (1.082) 2-[4-(4-chlorophenoxy)-2-(trifluoromethyl)phenyl]-1-(1H-1,2,4-triazol-1-yl)propan-2-ol, (1.083) 2-[6-(4-bromophenoxy)-2-(trifluoromethyl)-3-pyridyl]-1-(1,2,4-triazol-1-yl)propan-2-ol, (1.084) 2-[6-(4-chlorophenoxy)-2-(trifluoromethyl)-3-pyridyl]-1-(1,2,4-triazol-1-yl)propan-2-ol, (1.085) 3-[2-(1-chlorocyclopropyl)-3-(3-chloro-2-fluoro-phenyl)-2-hydroxy-propyl]imidazole-4-carbonitrile and (1.086) 4-[[6-[rac-(2R)-2-(2,4-difluorophenyl)-1,1-difluoro-2-hydroxy-3-(5-thioxo-4H-1,2,4-triazol-1-yl)propyl]-3-pyridyl]oxy]benzonitrile.

2) Inhibitors of the respiratory chain at complex I or II, for example (2.001) benzovindiflupyr, (2.002) bixafen, (2.003) boscalid, (2.004) carboxin, (2.005) fluopyram, (2.006) flutolanil, (2.007) fluxapyroxad, (2.008) furametpyr, (2.009) Isofetamid, (2.010) isopyrazam (anti-epimeric enantiomer 1R,4S,9S), (2.011) isopyrazam (anti-epimeric enantiomer 1S,4R,9R), (2.012) isopyrazam (anti-epimeric racemate 1RS,4SR,9SR), (2.013) isopyrazam (mixture of syn-epimeric racemate 1RS,4SR,9RS and anti-epimeric racemate 1RS,4SR,9SR), (2.014) isopyrazam (syn-epimeric enantiomer 1R,4S,9R), (2.015) isopyrazam (syn-epimeric enantiomer 1S,4R,9S), (2.016) isopyrazam (syn-epimeric racemate 1RS,4SR,9RS), (2.017) penflufen, (2.018) penthiopyrad, (2.019) pydiflumetofen, (2.020) Pyraziflumid, (2.021) sedaxane, (2.022) 1,3-dimethyl-N-(1,1,3-trimethyl-2,3-dihydro-1H-inden-4-yl)-1H-pyrazole-4-carboxamide, (2.023) 1,3-dimethyl-N-[(3R)-1,1,3-trimethyl-2,3-dihydro-1H-inden-4-yl]-1H-pyrazole-4-carboxamide, (2.024) 1,3-dimethyl-N-[(3S)-1,1,3-trimethyl-2,3-dihydro-1H-inden-4-yl]-1H-pyrazole-4-carboxamide, (2.025) 1-methyl-3-(trifluoromethyl)-N-[2′-(trifluoromethyl)biphenyl-2-yl]-1H-pyrazole-4-carboxamide, (2.026) 2-fluoro-6-(trifluoromethyl)-N-(1,1,3-trimethyl-2,3-dihydro-1H-inden-4-yl)benzamide, (2.027) 3-(difluoromethyl)-1-methyl-N-(1,1,3-trimethyl-2,3-dihydro-1H-inden-4-yl)-1H-pyrazole-4-carboxamide, (2.028) inpyrfluxam, (2.029) 3-(difluoromethyl)-1-methyl-N-[(3S)-1,1,3-trimethyl-2,3-dihydro-1H-inden-4-yl]-1H-pyrazole-4-carboxamide, (2.030) fluindapyr, (2.031) 3-(difluoromethyl)-N-[(3R)-7-fluoro-1,1,3-trimethyl-2,3-dihydro-1H-inden-4-yl]-1-methyl-1H-pyrazole-4-carboxamide, (2.032) 3-(difluoromethyl)-N-[(3S)-7-fluoro-1,1,3-trimethyl-2,3-dihydro-1H-inden-4-yl]-1-methyl-1H-pyrazole-4-carboxamide, (2.033) 5,8-difluoro-N-[2-(2-fluoro-4-{[4-(trifluoromethyl)pyridin-2-yl]oxy}phenyl)ethyl]quinazolin-4-amine, (2.034) N-(2-cyclopentyl-5-fluorobenzyl)-N-cyclopropyl-3-(difluoromethyl)-5-fluoro-1-methyl-1H-pyrazole-4-carboxamide, (2.035) N-(2-tert-butyl-5-methylbenzyl)-N-cyclopropyl-3-(difluoromethyl)-5-fluoro-1-methyl-1H-pyrazole-4-carboxamide, (2.036) N-(2-tert-butylbenzyl)-N-cyclopropyl-3-(difluoromethyl)-5-fluoro-1-methyl-1H-pyrazole-4-carboxamide, (2.037) N-(5-chloro-2-ethylbenzyl)-N-cyclopropyl-3-(difluoromethyl)-5-fluoro-1-methyl-1H-pyrazole-4-carboxamide, (2.038) isoflucypram, (2.039) N-[(1R,4S)-9-(dichloromethylene)-1,2,3,4-tetrahydro-1,4-methanonaphthalen-5-yl]-3-(difluoromethyl)-1-methyl-1H-pyrazole-4-carboxamide, (2.040) N-[(1S,4R)-9-(dichloromethylene)-1,2,3,4-tetrahydro-1,4-methanonaphthalen-5-yl]-3-(difluoromethyl)-1-methyl-1H-pyrazole-4-carboxamide, (2.041) N-[1-(2,4-dichlorophenyl)-1-methoxypropan-2-yl]-3-(difluoromethyl)-1-methyl-1H-pyrazole-4-carboxamide, (2.042) N-[2-chloro-6-(trifluoromethyl)benzyl]-N-cyclopropyl-3-(difluoromethyl)-5-fluoro-1-methyl-1H-pyrazole-4-carboxamide, (2.043) N-[3-chloro-2-fluoro-6-(trifluoromethyl)benzyl]-N-cyclopropyl-3-(difluoromethyl)-5-fluoro-1-methyl-1H-pyrazole-4-carboxamide, (2.044) N-[5-chloro-2-(trifluoromethyl)benzyl]-N-cyclopropyl-3-(difluoromethyl)-5-fluoro-1-methyl-1H-pyrazole-4-carboxamide, (2.045) N-cyclopropyl-3-(difluoromethyl)-5-fluoro-1-methyl-N-[5-methyl-2-(trifluoromethyl)benzyl]-1H-pyrazole-4-carboxamide, (2.046) N-cyclopropyl-3-(difluoromethyl)-5-fluoro-N-(2-fluoro-6-isopropylbenzyl)-1-methyl-1H-pyrazole-4-carboxamide, (2.047) N-cyclopropyl-3-(difluoromethyl)-5-fluoro-N-(2-isopropyl-5-methylbenzyl)-1-methyl-1H-pyrazole-4-carboxamide, (2.048) N-cyclopropyl-3-(difluoromethyl)-5-fluoro-N-(2-isopropylbenzyl)-1-methyl-1H-pyrazole-4-carbothioamide, (2.049) N-cyclopropyl-3-(difluoromethyl)-5-fluoro-N-(2-isopropylbenzyl)-1-methyl-1H-pyrazole-4-carboxamide, (2.050) N-cyclopropyl-3-(difluoromethyl)-5-fluoro-N-(5-fluoro-2-isopropylbenzyl)-1-methyl-1H-pyrazole-4-carboxamide, (2.051) N-cyclopropyl-3-(difluoromethyl)-N-(2-ethyl-4,5-dimethylbenzyl)-5-fluoro-1-methyl-1H-pyrazole-4-carboxamide, (2.052) N-cyclopropyl-3-(difluoromethyl)-N-(2-ethyl-5-fluorobenzyl)-5-fluoro-1-methyl-1H-pyrazole-4-carboxamide, (2.053) N-cyclopropyl-3-(difluoromethyl)-N-(2-ethyl-5-methylbenzyl)-5-fluoro-1-methyl-1H-pyrazole-4-carboxamide, (2.054) N-cyclopropyl-N-(2-cyclopropyl-5-fluorobenzyl)-3-(difluoromethyl)-5-fluoro-1-methyl-1H-pyrazole-4-carboxamide, (2.055) N-cyclopropyl-N-(2-cyclopropyl-5-methylbenzyl)-3-(difluoromethyl)-5-fluoro-1-methyl-1H-pyrazole-4-carboxamide, (2.056) N-cyclopropyl-N-(2-cyclopropylbenzyl)-3-(difluoromethyl)-5-fluoro-1-methyl-1H-pyrazole-4-carboxamide, (2.057) pyrapropoyne.

3) Inhibitors of the respiratory chain at complex III, for example (3.001) ametoctradin, (3.002) amisulbrom, (3.003) azoxystrobin, (3.004) coumethoxystrobin, (3.005) coumoxystrobin, (3.006) cyazofamid, (3.007) dimoxystrobin, (3.008) enoxastrobin, (3.009) famoxadone, (3.010) fenamidone, (3.011) flufenoxystrobin, (3.012) fluoxastrobin, (3.013) kresoxim-methyl, (3.014) metominostrobin, (3.015) orysastrobin, (3.016) picoxystrobin, (3.017) pyraclostrobin, (3.018) pyrametostrobin, (3.019) pyraoxystrobin, (3.020) trifloxystrobin, (3.021) (2E)-2-{2-[({[(1E)-1-(3-{[(E)-1-fluoro-2-phenylvinyl]oxy}phenyl)ethylidene]amino}oxy)methyl]phenyl}-2-(methoxyimino)-N-methylacetamide, (3.022) (2E,3Z)-5-{[1-(4-chlorophenyl)-1H-pyrazol-3-yl]oxy}-2-(methoxyimino)-N,3-dimethylpent-3-enamide, (3.023) (2R)-2-{2-[(2,5-dimethylphenoxy)methyl]phenyl}-2-methoxy-N-methylacetamide, (3.024) (2S)-2-{2-[(2,5-dimethylphenoxy)methyl]phenyl}-2-methoxy-N-methylacetamide, (3.025) fenpicoxamid, (3.026) mandestrobin, (3.027) N-(3-ethyl-3,5,5-trimethylcyclohexyl)-3-formamido-2-hydroxybenzamide, (3.028) (2E,3Z)-5-{[1-(4-chloro-2-fluorophenyl)-1H-pyrazol-3-yl]oxy}-2-(methoxyimino)-N,3-dimethylpent-3-enamide, (3.029) methyl {5-[3-(2,4-dimethylphenyl)-1H-pyrazol-1-yl]-2-methylbenzyl}carbamate, (3.030) metyltetraprole, (3.031) florylpicoxamid.

4) Inhibitors of the mitosis and cell division, for example (4.001) carbendazim, (4.002) diethofencarb, (4.003) ethaboxam, (4.004) fluopicolide, (4.005) pencycuron, (4.006) thiabendazole, (4.007) thiophanate-methyl, (4.008) zoxamide, (4.009) 3-chloro-4-(2,6-difluorophenyl)-6-methyl-5-phenylpyridazine, (4.010) 3-chloro-5-(4-chlorophenyl)-4-(2,6-difluorophenyl)-6-methylpyridazine, (4.011) 3-chloro-5-(6-chloropyridin-3-yl)-6-methyl-4-(2,4,6-trifluorophenyl)pyridazine, (4.012) 4-(2-bromo-4-fluorophenyl)-N-(2,6-difluorophenyl)-1,3-dimethyl-1H-pyrazol-5-amine, (4.013) 4-(2-bromo-4-fluorophenyl)-N-(2-bromo-6-fluorophenyl)-1,3-dimethyl-1H-pyrazol-5-amine, (4.014) 4-(2-bromo-4-fluorophenyl)-N-(2-bromophenyl)-1,3-dimethyl-1H-pyrazol-5-amine, (4.015) 4-(2-bromo-4-fluorophenyl)-N-(2-chloro-6-fluorophenyl)-1,3-dimethyl-1H-pyrazol-5-amine, (4.016) 4-(2-bromo-4-fluorophenyl)-N-(2-chlorophenyl)-1,3-dimethyl-1H-pyrazol-5-amine, (4.017) 4-(2-bromo-4-fluorophenyl)-N-(2-fluorophenyl)-1,3-dimethyl-1H-pyrazol-5-amine, (4.018) 4-(2-chloro-4-fluorophenyl)-N-(2,6-difluorophenyl)-1,3-dimethyl-1H-pyrazol-5-amine, (4.019) 4-(2-chloro-4-fluorophenyl)-N-(2-chloro-6-fluorophenyl)-1,3-dimethyl-1H-pyrazol-5-amine, (4.020) 4-(2-chloro-4-fluorophenyl)-N-(2-chlorophenyl)-1,3-dimethyl-1H-pyrazol-5-amine, (4.021) 4-(2-chloro-4-fluorophenyl)-N-(2-fluorophenyl)-1,3-dimethyl-1H-pyrazol-5-amine, (4.022) 4-(4-chlorophenyl)-5-(2,6-difluorophenyl)-3,6-dimethylpyridazine, (4.023) N-(2-bromo-6-fluorophenyl)-4-(2-chloro-4-fluorophenyl)-1,3-dimethyl-1H-pyrazol-5-amine, (4.024) N-(2-bromophenyl)-4-(2-chloro-4-fluorophenyl)-1,3-dimethyl-1H-pyrazol-5-amine, (4.025) N-(4-chloro-2,6-difluorophenyl)-4-(2-chloro-4-fluorophenyl)-1,3-dimethyl-1H-pyrazol-5-amine.

5) Compounds capable to have a multisite action, for example (5.001) bordeaux mixture, (5.002) captafol, (5.003) captan, (5.004) chlorothalonil, (5.005) copper hydroxide, (5.006) copper naphthenate, (5.007) copper oxide, (5.008) copper oxychloride, (5.009) copper(2+) sulfate, (5.010) dithianon, (5.011) dodine, (5.012) folpet, (5.013) mancozeb, (5.014) maneb, (5.015) metiram, (5.016) metiram zinc, (5.017) oxine-copper, (5.018) propineb, (5.019) sulfur and sulfur preparations including calcium polysulfide, (5.020) thiram, (5.021) zineb, (5.022) ziram, (5.023) 6-ethyl-5,7-dioxo-6,7-dihydro-5H-pyrrolo[3′,4′:5,6][1,4]dithiino[2,3-c][1,2]thiazole-3-carbonitrile.

6) Compounds capable to induce a host defence, for example (6.001) acibenzolar-S-methyl, (6.002) isotianil, (6.003) probenazole, (6.004) tiadinil.

7) Inhibitors of the amino acid and/or protein biosynthesis, for example (7.001) cyprodinil, (7.002) kasugamycin, (7.003) kasugamycin hydrochloride hydrate, (7.004) oxytetracycline, (7.005) pyrimethanil, (7.006) 3-(5-fluoro-3,3,4,4-tetramethyl-3,4-dihydroisoquinolin-1-yl)quinolone.

8) Inhibitors of the ATP production, for example (8.001) silthiofam.

9) Inhibitors of the cell wall synthesis, for example (9.001) benthiavalicarb, (9.002) dimethomorph, (9.003) flumorph, (9.004) iprovalicarb, (9.005) mandipropamid, (9.006) pyrimorph, (9.007) valifenalate, (9.008) (2E)-3-(4-tert-butylphenyl)-3-(2-chloropyridin-4-yl)-1-(morpholin-4-yl)prop-2-en-1-one, (9.009) (2Z)-3-(4-tert-butylphenyl)-3-(2-chloropyridin-4-yl)-1-(morpholin-4-yl)prop-2-en-1-one.

10) Inhibitors of the lipid and membrane synthesis, for example (10.001) propamocarb, (10.002) propamocarb hydrochloride, (10.003) tolclofos-methyl.

11) Inhibitors of the melanin biosynthesis, for example (11.001) tricyclazole, (11.002) tolprocarb.

12) Inhibitors of the nucleic acid synthesis, for example (12.001) benalaxyl, (12.002) benalaxyl-M (kiralaxyl), (12.003) metalaxyl, (12.004) metalaxyl-M (mefenoxam).

13) Inhibitors of the signal transduction, for example (13.001) fludioxonil, (13.002) iprodione, (13.003) procymidone, (13.004) proquinazid, (13.005) quinoxyfen, (13.006) vinclozolin.

14) Compounds capable to act as an uncoupler, for example (14.001) fluazinam, (14.002) meptyldinocap.

15) Other fungicides, for example (15.001) abscisic acid, (15.002) benthiazole, (15.003) bethoxazin, (15.004) capsimycin, (15.005) carvone, (15.006) chinomethionat, (15.007) cufraneb, (15.008) cyflufenamid, (15.009) cymoxanil, (15.010) cyprosulfamide, (15.011) flutianil, (15.012) fosetyl-aluminium, (15.013) fosetyl-calcium, (15.014) fosetyl-sodium, (15.015) methyl isothiocyanate, (15.016) metrafenone, (15.017) mildiomycin, (15.018) natamycin, (15.019) nickel dimethyldithiocarbamate, (15.020) nitrothal-isopropyl, (15.021) oxamocarb, (15.022) Oxathiapiprolin, (15.023) oxyfenthiin, (15.024) pentachlorophenol and salts, (15.025) phosphorous acid and its salts, (15.026) propamocarb-fosetylate, (15.027) pyriofenone (chlazafenone), (15.028) tebufloquin, (15.029) tecloftalam, (15.030) tolnifanide, (15.031) 1-(4-{4-[(5R)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.032) 1-(4-{4-[(5S)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.033) 2-(6-benzylpyridin-2-yl)quinazoline, (15.034) dipymetitrone, (15.035) 2-[3,5-bis(difluoromethyl)-1H-pyrazol-1-yl]-1-[4-(4-{5-[2-(prop-2-yn-1-yloxy)phenyl]-4,5-dihydro-1,2-oxazol-3-yl}-1,3-thiazol-2-yl)piperidin-1-yl]ethanone, (15.036) 2-[3,5-bis(difluoromethyl)-1H-pyrazol-1-yl]-1-[4-(4-{5-[2-chloro-6-(prop-2-yn-1-yloxy)phenyl]-4,5-dihydro-1,2-oxazol-3-yl}-1,3-thiazol-2-yl)piperidin-1-yl]ethanone, (15.037) 2-[3,5-bis(difluoromethyl)-1H-pyrazol-1-yl]-1-[4-(4-{5-[2-fluoro-6-(prop-2-yn-1-yloxy)phenyl]-4,5-dihydro-1,2-oxazol-3-yl}-1,3-thiazol-2-yl)piperidin-1-yl]ethanone, (15.038) 2-[6-(3-fluoro-4-methoxyphenyl)-5-methylpyridin-2-yl]quinazoline, (15.039) 2-{(5R)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.040) 2-{(5S)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.041) Ipflufenoquin, (15.042) 2-{2-fluoro-6-[(8-fluoro-2-methylquinolin-3-yl)oxy]phenyl}propan-2-ol, (15.043)fluoxapiprolin, (15.044) 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}phenyl methanesulfonate, (15.045) 2-phenylphenol and salts, (15.046) 3-(4,4,5-trifluoro-3,3-dimethyl-3,4-dihydroisoquinolin-1-yl)quinoline, (15.047) quinofumelin, (15.048) 4-amino-5-fluoropyrimidin-2-ol (tautomeric form: 4-amino-5-fluoropyrimidin-2(1H)-one), (15.049) 4-oxo-4-[(2-phenylethyl)amino]butanoic acid, (15.050) 5-amino-1,3,4-thiadiazole-2-thiol, (15.051) 5-chloro-N′-phenyl-N′-(prop-2-yn-1-yl)thiophene-2-sulfonohydrazide, (15.052) 5-fluoro-2-[(4-fluorobenzyl)oxy]pyrimidin-4-amine, (15.053) 5-fluoro-2-[(4-methylbenzyl)oxy]pyrimidin-4-amine, (15.054) 9-fluoro-2,2-dimethyl-5-(quinolin-3-yl)-2,3-dihydro-1,4-benzoxazepine, (15.055) but-3-yn-1-yl {6-[({[(Z)-(1-methyl-1H-tetrazol-5-yl)(phenyl)methylene]amino}oxy)methyl]pyridin-2-yl}carbamate, (15.056) ethyl (2Z)-3-amino-2-cyano-3-phenylacrylate, (15.057) phenazine-1-carboxylic acid, (15.058) propyl 3,4,5-trihydroxybenzoate, (15.059) quinolin-8-ol, (15.060) quinolin-8-ol sulfate (2:1), (15.061) tert-butyl {6-[({[(1-methyl-1H-tetrazol-5-yl)(phenyl)methylene]amino}oxy)methyl]pyridin-2-yl}carbamate, (15.062) 5-fluoro-4-imino-3-methyl-1-[(4-methylphenyl)sulfonyl]-3,4-dihydropyrimidin-2(1H)-one, (15.063) aminopyrifen, (15.064) (N′-[2-chloro-4-(2-fluorophenoxy)-5-methylphenyl]-N-ethyl-N-methylimidoformamide), (15.065) (N′-(2-chloro-5-methyl-4-phenoxyphenyl)-N-ethyl-N-methylimidoformamide), (15.066) (2-{2-[(7,8-difluoro-2-methylquinolin-3-yl)oxy]-6-fluorophenyl}propan-2-ol), (15.067) (5-bromo-1-(5,6-dimethylpyridin-3-yl)-3,3-dimethyl-3,4-dihydroisoquinoline), (15.068) (3-(4,4-difluoro-5,5-dimethyl-4,5-dihydrothieno[2,3-c]pyridin-7-yl)quinoline), (15.069) (1-(4,5-dimethyl-1H-benzimidazol-1-yl)-4,4-difluoro-3,3-dimethyl-3,4-dihydroisoquinoline), (15.070) 8-fluoro-3-(5-fluoro-3,3-dimethyl-3,4-dihydroisoquinolin-1-yl)quinolone, (15.071) 8-fluoro-3-(5-fluoro-3,3,4,4-tetramethyl-3,4-dihydroisoquinolin-1-yl)quinolone, (15.072) 3-(4,4-difluoro-3,3-dimethyl-3,4-dihydroisoquinolin-1-yl)-8-fluoroquinoline, (15.073) (N-methyl-N-phenyl-4-[5-(trifluoromethyl)-1,2,4-oxadiazol-3-yl]benzamide), (15.074) (methyl{4-[5-(trifluoromethyl)-1,2,4-oxadiazol-3-yl]phenyl}carbamate), (15.075) (N-{4-[5-(trifluoromethyl)-1,2,4-oxadiazol-3-yl]benzyl}cyclopropanecarboxamide), (15.076) N-methyl-4-(5-(trifluoromethyl)-1,2,4-oxadiazol-3-yl]benzamide, (15.077) N-[(E)-methoxyiminomethyl]-4-[5-(trifluoromethyl)-1,2,4-oxadiazol-3-yl]benzamide, (15.078) N—[(Z)-methoxyiminomethyl]-4-[5-(trifluoromethyl)-1,2,4-oxadiazol-3-yl]benzamide, (15.079) N-[4-[5-(trifluoromethyl)-1,2,4-oxadiazol-3-yl]phenyl]cyclopropanecarboxamide, (15.080) N-(2-fluorophenyl)-4-[5-(trifluoromethyl)-1,2,4-oxadiazol-3-yl]benzamide, (15.081) 2,2-difluoro-N-methyl-2-[4-[5-(trifluoromethyl)-1,2,4-oxadiazol-3-yl]phenyl]-acetamide, (15.082) N-allyl-N-[[4-[5-(trifluoromethyl)-1,2,4-oxadiazol-3-yl)phenyl]methyl]acetamide, (15.083) N-[(E)-N-methoxy-C-methyl-carbonimidoyl]-4-(5-(trifluoromethyl)-1,2,4-oxadiazol-3-yl]-benzamide, (15.084) N—[(Z)—N-methoxy-C-methyl-carbonimidoyl]-4-[5-(trifluoromethyl)-1,2,4-oxadiazol-3-yl]benzamide, (15.085) N-allyl-N-[[4-[5-(trifluoromethyl)-1,2,4-oxadiazol-3-yl]phenyl]methyl]-propanamide, (15.086) 4,4-dimethyl-1-[[4-[5-(trifluoromethyl)-1,2,4-oxadiazol-3-yl]phenyl]methyl]-pyrrolidin-2-one, (15.087) N-methyl-4-[5-(trifluoromethyl)-1,2,4-oxadiazol-3-yl]benzenecarbothioamide, (15.088) 5-methyl-1-[[4-[5-(trifluoromethyl)-1,2,4-oxadiazol-3-yl]phenyl]methyl]pyrrolidin-2-one, (15.089) N-((2,3-difluoro-4-[5-(trifluoromethyl)-1,2,4-oxadiazol-3-yl]phenyl]methyl]-3,3,3-trifluoro-propanamide, (15.090) 1-methoxy-1-methyl-3-[[4-[5-(trifluoromethyl}-1,2,4-oxadiazol-3-yl]phenyl]-methyl]urea, (15.091) 1,1-diethyl-3-[[4-[5-(trifluoromethyl}-1,2,4-oxadiazol-3-yl]phenyl]methyl]urea, (15.092) N-[[4-[5-(trifluoromethyl)-1,2,4-oxadiazol-3-yl]phenyl]methyl]propanamide, (15.093) N-methoxy-N-[[4-[5-(trifluoromethyl)-1,2,4-oxadiazol-3-yl]phenyl]methyl]cyclopropanecarboxamide, (15.094) 1-methoxy-3-methyl-1-[[4-[5-(trifluoromethyl)-1,2,4-oxadiazol-3-yl]phenyl]methyl]urea, (15.095) N-methoxy-N-[[4-[5-(trifluoromethyl)-1,2,4-oxadiazol-3-yl]phenyl]methyl)cyclopropanecarboxamide, (15.096) N,2-dimethoxy-N-[[4-[5-(trifluoromethyl}-1,2,4-oxadiazol-3-yl]phenyl]methyl]-propanamide, (15.097) N-ethyl-2-methyl-N-[[4-[5-(trifluoromethyl)-1,2,4-oxadiazol-3-yl)phenyl]methyl]-propanamide, (15.098) 1-methoxy-3-methyl-1-[[4-[5-(trifluoromethyl)-1,2,4-oxadiazol-3-yl]phenyl]-methyl]urea, (15.099) 1,3-dimethoxy-1-[[4-[5-(trifluoromethyl)-1,2,4-oxadiazol-3-yl]phenyl]methyl]urea, (15.100) 3-ethyl-1-methoxy-1-[[4-[5-(trifluoromethyl)-1,2,4-oxadiazol-3-yl]phenyl]methyl]urea, (15.101) 1-[[4-[5-(trifluoromethyl)-1,2,4-oxadiazol-3-yl]phenyl]methyl]piperidin-2-one, (15.102) 4,4-dimethyl-2-[[4-[5-(trifluoromethyl)-1,2,4-oxadiazol-3-yl]phenyl]methyl]isooxazolidin-3-one, (15.103) 5,5-dimethyl-2-[[4-[5-(trifluoromethyl)-1,2,4-oxadiazol-3-yl]phenyl]methyl]isoxazolidin-3-one, (15.104) 3,3-dimethyl-1-[[4-[5-(trifluoromethyl)-1,2,4-oxadiazol-3-yl]phenyl]methyl]piperidin-2-one, (15.105) 1-[[3-fluoro-4-(5-(trifluoromethyl)-1,2,4-oxadiazol-3-yl]phenyl]methyl]azepan-2-one, (15.106) 4,4-dimethyl-2-[[4-(5-(trifluoromethyl)-1,2,4-oxadiazol-3-yl]phenyl]methyl]isoxazolidin-3-one (15.107) 5,5-dimethyl-2-[[4-[5-(trifluoromethyl)-1,2,4-oxadiazol-3-yl]phenyl]methyl]isoxazolidin-3-one, (15.108) ethyl (1-{4-[5-(trifluoromethyl)-1,2,4-oxadiazol-3-yl]benzyl}-1H-pyrazol-4-yl)acetate, (15.109) N,N-dimethyl-1-{4-[5-(trifluoromethyl)-1,2,4-oxadiazol-3-yl]benzyl}-1H-1,2,4-triazol-3-amine, (15.110) N-{2,3-difluoro-4-[5-(trifluoromethyl)-1,2,4-oxadiazol-3-yl]benzyl}butanamide, (15.111) N-(1-methylcyclopropyl)-4-[5-(trifluoromethyl)-1,2,4-oxadiazol-3-yl]benzamide, (15.112) N-(2,4-difluorophenyl)-4-[5-(trifluoromethyl)-1,2,4-oxadiazol-3-yl]benzamide, (15.113) 1-(5,6-dimethylpyridin-3-yl)-4,4-difluoro-3,3-dimethyl-3,4-dihydroisoquinoline, (15.114) 1-(6-(difluoromethyl)-5-methyl-pyridin-3-yl)-4,4-difluoro-3,3-dimethyl-3,4-dihydroisoquinoline, (15.115) 1-(5-(fluoromethyl)-6-methyl-pyridin-3-yl)-4,4-difluoro-3,3-dimethyl-3,4-dihydroisoquinoline and (15.116) 1-(6-(difluoromethyl)-5-methoxy-pyridin-3-yl)-4,4-difluoro-3,3-dimethyl-3,4-dihydroisoquinoline.

All named mixing partners of the classes (1) to (15) as described here above can be present in the form of the free compound or, if their functional groups enable this, an agrochemically active salt thereof.

Examples of Insecticides as compound c) are:

(1) Acetylcholinesterase (AChE) inhibitors, preferably carbamates selected from alanycarb, aldicarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, triazamate, trimethacarb, XMC and xylylcarb, or organophosphates selected from acephate, azamethiphos, azinphos-ethyl, azinphos-methyl, cadusafos, chlorethoxyfos, chlorfenvinphos, chlormephos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, imicyafos, isofenphos, isopropyl O-(methoxyaminothiophosphoryl) salicylate, isoxathion, malathion, mecarbam, methamidophos, methidathion, mevinphos, monocrotophos, naled, omethoate, oxydemeton-methyl, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, triclorfon and vamidothion.

(2) GABA-gated chloride channel blockers, preferably cyclodiene-organochlorines selected from chlordane and endosulfan, or phenylpyrazoles (fiproles) selected from ethiprole and fipronil.

(3) Sodium channel modulators, preferably pyrethroids selected from acrinathrin, allethrin, d-cis-trans allethrin, d-trans allethrin, bifenthrin, bioallethrin, bioallethrin s-cyclopentenyl isomer, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin [(1R)-trans-isomer], deltamethrin, empenthrin [(EZ)-(1R)-isomer], esfenvalerate, etofenprox, fenpropathrin, fenvalerate, flucythrinate, flumethrin, tau-fluvalinate, halfenprox, imiprothrin, kadethrin, momfluorothrin, permethrin, phenothrin [(1R)-trans-isomer], prallethrin, pyrethrins (pyrethrum), resmethrin, silafluofen, tefluthrin, tetramethrin, tetramethrin [(1R)-isomer)], tralomethrin and transfluthrin or DDT or methoxychlor.

(4) Nicotinic acetylcholine receptor (nAChR) competitive modulators, preferably neonicotinoids selected from acetamiprid, clothianidin, dinotefuran, imidacloprid, nitenpyram, thiacloprid and thiamethoxam, or nicotine, or sulfoximines selected from sulfoxaflor, or butenolids selected from flupyradifurone, or mesoionics selected from triflumezopyrim.

(5) Nicotinic acetylcholine receptor (nAChR) allosteric modulators, preferably spinosyns selected from spinetoram and spinosad.

(6) Glutamate-gated chloride channel (GluCl) allosteric modulators, preferably avermectins/milbemycins selected from abamectin, emamectin benzoate, lepimectin and milbemectin.

(7) Juvenile hormone mimics, preferably juvenile hormone analogues selected from hydroprene, kinoprene and methoprene, or fenoxycarb or pyriproxyfen.

(8) Miscellaneous non-specific (multi-site) inhibitors, preferably alkyl halides selected from methyl bromide and other alkyl halides, or chloropicrine or sulphuryl fluoride or borax or tartar emetic or methyl isocyanate generators selected from diazomet and metam.

(9) Chordotonal organ TRPV channel modulators selected from pymetrozine and pyrifluquinazone.

(10) Mite growth inhibitors selected from clofentezine, hexythiazox, diflovidazin and etoxazole.

(11) Microbial disruptors of the insect gut membrane selected from Bacillus thuringiensis subspecies israelensis, Bacillus sphaericus, Bacillus thuringiensis subspecies aizawai, Bacillus thuringiensis subspecies kurstaki, Bacillus thuringiensis subspecies tenebrionis, and B.t. plant proteins selected from Cry1Ab, Cry1Ac, Cry1Fa, Cry1A.105, Cry2Ab, Vip3A, mCry3A, Cry3Ab, Cry3Bb and Cry34Ab1/35Ab1.

(12) Inhibitors of mitochondrial ATP synthase, preferably ATP disruptors selected from diafenthiuron, or organotin compounds selected from azocyclotin, cyhexatin and fenbutatin oxide, or propargite or tetradifon.

(13) Uncouplers of oxidative phosphorylation via disruption of the proton gradient selected from chlorfenapyr, DNOC and sulfluramid.

(14) Nicotinic acetylcholine receptor channel blockers selected from bensultap, cartap hydrochloride, thiocylam and thiosultap-sodium.

(15) Inhibitors of chitin biosynthesis, type 0, selected from bistrifluron, chlorfluazuron, diflubenzuron, flucycloxuron, flufenoxuron, hexaflumuron, lufenuron, novaluron, noviflumuron, teflubenzuron and triflumuron.

(16) Inhibitors of chitin biosynthesis, type 1 selected from buprofezin.

(17) Moulting disruptor (in particular for Diptera, i.e. dipterans) selected from cyromazine.

(18) Ecdysone receptor agonists selected from chromafenozide, halofenozide, methoxyfenozide and tebufenozide.

(19) Octopamine receptor agonists selected from amitraz.

(20) Mitochondrial complex III electron transport inhibitors selected from hydramethylnone, acequinocyl and fluacrypyrim.

(21) Mitochondrial complex I electron transport inhibitors, preferably METI acaricides selected from fenazaquin, fenpyroximate, pyrimidifen, pyridaben, tebufenpyrad and tolfenpyrad, or rotenone (Derris).

(22) Voltage-dependent sodium channel blockers selected from indoxacarb and metaflumizone.

(23) Inhibitors of acetyl CoA carboxylase, preferably tetronic and tetramic acid derivatives selected from spirodiclofen, spiromesifen and spirotetramat.

(24) Mitochondrial complex IV electron transport inhibitors, preferably phosphines selected from aluminium phosphide, calcium phosphide, phosphine and zinc phosphide, or cyanides selected from calcium cyanide, potassium cyanide and sodium cyanide.

(25) Mitochondrial complex II electron transport inhibitors, preferably beta-ketonitrile derivatives selected from cyenopyrafen and cyflumetofen, and carboxanilides selected from pyflubumide.

(28) Ryanodine receptor modulators, preferably diamides selected from chlorantraniliprole, cyantraniliprole and flubendiamide.

(29) Chordotonal organ Modulators (with undefined target site) selected from flonicamid.

(30) Further active compounds selected from Acynonapyr, Afidopyropen, Afoxolaner, Azadirachtin, Benclothiaz, Benzoximate, Benzpyrimoxan, Bifenazate, Broflanilide, Bromopropylate, Chinomethionat, Chloroprallethrin, Cryolite, Cyclaniliprole, Cycloxaprid, Cyhalodiamide, Dicloromezotiaz, Dicofol, Dimpropyridaz, epsilon-Metofluthrin, epsilon-Momfluthrin, Flometoquin, Fluazaindolizine, Fluensulfone, Flufenerim, Flufenoxystrobin, Flufiprole, Fluhexafon, Fluopyram, Flupyrimin, Fluralaner, Fluxametamide, Fufenozide, Guadipyr, Heptafluthrin, Imidaclothiz, Iprodione, Isocycloseram, kappa-Bifenthrin, kappa-Tefluthrin, Lotilaner, Meperfluthrin, Oxazosulfyl, Paichongding, Pyridalyl, Pyrifluquinazon, Pyriminostrobin, Spirobudiclofen, Spiropidion, Tetramethylfluthrin, Tetraniliprole, Tetrachlorantraniliprole, Tigolaner, Tioxazafen, Thiofluoximate iodomethane; furthermore preparations based on Bacillus firmus (I-1582, BioNeem, Votivo), and also the following compounds: 1-{2-fluoro-4-methyl-5-[(2,2,2-trifluoroethyl)sulphinyl]phenyl}-3-(trifluoromethyl)-1H-1,2,4-triazole-5-amine (known from WO2006/043635) (CAS 885026-50-6), {1′-[(2E)-3-(4-chlorophenyl)prop-2-en-1-yl]-5-fluorospiro[indol-3,4′-piperidin]-1(2H)-yl}(2-chloropyridin-4-yl)methanone (known from WO2003/106457) (CAS 637360-23-7), 2-chloro-N-[2-{1-[(2E)-3-(4-chlorophenyl)prop-2-en-1-yl]piperidin-4-yl}-4-(trifluoromethyl)phenyl]isonicotinamide (known from WO2006/003494) (CAS 872999-66-1), 3-(4-chloro-2,6-dimethylphenyl)-4-hydroxy-8-methoxy-1,8-diazaspiro[4.5]dec-3-en-2-one (known from WO 2010052161) (CAS 1225292-17-0), 3-(4-chloro-2,6-dimethylphenyl)-8-methoxy-2-oxo-1,8-diazaspiro[4.5]dec-3-en-4-yl ethyl carbonate (known from EP2647626) (CAS 1440516-42-6), 4-(but-2-yn-1-yloxy)-6-(3,5-dimethylpiperidin-1-yl)-5-fluoropyrimidine (known from WO2004/099160) (CAS 792914-58-0), PF1364 (known from JP2010/018586) (CAS 1204776-60-2), (3E)-3-[1-[(6-chloro-3-pyridyl)methyl]-2-pyridylidene]-1,1,1-trifluoro-propan-2-one (known from WO2013/144213) (CAS 1461743-15-6), N-[3-(benzylcarbamoyl)-4-chlorophenyl]-1-methyl-3-(pentafluoroethyl)-4-(trifluoromethyl)-1H-pyrazole-5-carboxamide (known from WO2010/051926) (CAS 1226889-14-0), 5-bromo-4-chloro-N-[4-chloro-2-methyl-6-(methylcarbamoyl)phenyl]-2-(3-chloro-2-pyridyl)pyrazole-3-carboxamide (known from CN103232431) (CAS 1449220-44-3), 4-[5-(3,5-dichlorophenyl)-4,5-dihydro-5-(trifluoromethyl)-3-isoxazolyl]-2-methyl-N-(cis-1-oxido-3-thietanyl)-benzamide, 4-[5-(3,5-dichlorophenyl)-4,5-dihydro-5-(trifluoromethyl)-3-isoxazolyl]-2-methyl-N-(trans-1-oxido-3-thietanyl)-benzamide and 4-[(5S)-5-(3,5-dichlorophenyl)-4,5-dihydro-5-(trifluoromethyl)-3-isoxazolyl]-2-methyl-N-(cis-1-oxido-3-thietanyl)benzamide (known from WO 2013/050317 A1) (CAS 1332628-83-7), N-[3-chloro-1-(3-pyridinyl)-1H-pyrazol-4-yl]-N-ethyl-3-[(3,3,3-trifluoropropyl)sulfinyl]-propanamide, (+)-N-[3-chloro-1-(3-pyridinyl)-1H-pyrazol-4-yl]-N-ethyl-3-[(3,3,3-trifluoropropyl)sulfinyl]-propanamide and (−)-N-[3-chloro-1-(3-pyridinyl)-1H-pyrazol-4-yl]-N-ethyl-3-[(3,3,3-trifluoropropyl)sulfinyl]-propanamide (known from WO 2013/162715 A2, WO 2013/162716 A2, US 2014/0213448 A1) (CAS 1477923-37-7), 5-[[(2E)-3-chloro-2-propen-1-yl]amino]-1-[2,6-dichloro-4-(trifluoromethyl)phenyl]-4-[(trifluoromethyl)sulfinyl]-1H-pyrazole-3-carbonitrile (known from CN 101337937 A) (CAS 1105672-77-2), 3-bromo-N-[4-chloro-2-methyl-6-[(methylamino)thioxomethyl]phenyl]-1-(3-chloro-2-pyridinyl)-1H-pyrazole-5-carboxamide, (Liudaibenjiaxuanan, known from CN 103109816 A) (CAS 1232543-85-9); N-[4-chloro-2-[[(1,1-dimethylethyl) amino]carbonyl]-6-methylphenyl]-1-(3-chloro-2-pyridinyl)-3-(fluoromethoxy)-1H-pyrazole-5-carboxamide (known from WO 2012/034403 A1) (CAS 1268277-22-0), N-[2-(5-amino-1,3,4-thiadiazol-2-yl)-4-chloro-6-methylphenyl]-3-bromo-1-(3-chloro-2-pyridinyl)-1H-pyrazole-5-carboxamide (known from WO 2011/085575 A1) (CAS 1233882-22-8), 4-[3-[2,6-dichloro-4-[(3,3-dichloro-2-propen-1-yl)oxylphenoxy]propoxy]-2-methoxy-6-(trifluoromethyl)-pyrimidine (known from CN 101337940 A) (CAS 1108184-52-6); (2E)- and 2(Z)-2-[2-(4-cyanophenyl)-1-[3-(trifluoromethyl)phenyl]ethylidene]-N-[4-(difluoromethoxy)phenyl]-hydrazinecarboxamide (known from CN 101715774 A) (CAS 1232543-85-9); 3-(2,2-dichloroethenyl)-2,2-dimethyl-4-(1H-benzimidazol-2-yl)phenyl-cyclopropanecarboxylic acid ester (known from CN 103524422 A) (CAS 1542271-46-4); (4aS)-7-chloro-2,5-dihydro-2-[[(methoxycarbonyl)[4-[(trifluoromethyl)thio]phenyl]amino]carbonyl]-indeno[1,2-e][1,3,4]oxadiazine-4a(3H)-carboxylic acid methyl ester (known from CN 102391261 A) (CAS 1370358-69-2); 6-deoxy-3-O-ethyl-2,4-di-O-methyl-, 1-[N-[4-[1-[4-(1,1,2,2,2-pentafluoroethoxy)phenyl]-1H-1,2,4-triazol-3-yl]phenyl]carbamate]-α-L-mannopyranose (known from US 2014/0275503 A1) (CAS 1181213-14-8); 8-(2-cyclopropylmethoxy-4-trifluoromethyl-phenoxy)-3-(6-trifluoromethyl-pyridazin-3-yl)-3-aza-bicyclo[3.2.1]octane (CAS 1253850-56-4), (8-anti)-8-(2-cyclopropylmethoxy-4-trifluoromethyl-phenoxy)-3-(6-trifluoromethyl-pyridazin-3-yl)-3-aza-bicyclo[3.2.1]octane (CAS 933798-27-7), (8-syn)-8-(2-cyclopropylmethoxy-4-trifluoromethyl-phenoxy)-3-(6-trifluoromethyl-pyridazin-3-yl)-3-aza-bicyclo[3.2.1]octane (known from WO 2007040280 A1, WO 2007040282 A1) (CAS 934001-66-8), N-[3-chloro-1-(3-pyridinyl)-1H-pyrazol-4-yl]-N-ethyl-3-[(3,3,3-trifluoropropyl)thio]-propanamide (known from WO 2015/058021 A1, WO 2015/058028 A1) (CAS 1477919-27-9) and N-[4-(aminothioxomethyl)-2-methyl-6-[(methylamino)carbonyl]phenyl]-3-bromo-1-(3-chloro-2-pyridinyl)-1H-pyrazole-5-carboxamide (known from CN 103265527 A) (CAS 1452877-50-7), 5-(1,3-dioxan-2-yl)-4-[[4-(trifluoromethyl)phenyl]methoxy]-pyrimidine (known from WO 2013/115391 A1) (CAS 1449021-97-9), 3-(4-chloro-2,6-dimethylphenyl)-8-methoxy-1-methyl-1,8-diazaspiro[4.5]decane-2,4-dione (known from WO 2014/187846 A1) (CAS 1638765-58-8), 3-(4-chloro-2,6-dimethylphenyl)-8-methoxy-1-methyl-2-oxo-1,8-diazaspiro[4.5]dec-3-en-4-yl-carbonic acid ethyl ester (known from WO 2010/066780 A1, WO 2011151146 A1) (CAS 1229023-00-0), 4-[(5S)-5-(3,5-dichloro-4-fluorophenyl)-4,5-dihydro-5-(trifluoromethyl)-3-isoxazolyl]-N-[(4R)-2-ethyl-3-oxo-4-isoxazolidinyl]-2-methyl-benzamide (known from WO 2011/067272, WO2013/050302) (CAS 1309959-62-3).

Biologics: Biological spores might be added to the formulation or be encapsulated as well.

Useful organic solvents d) include all customary organic solvents that have low miscibility with water. Preferred examples include aliphatic and aromatic, optionally halogenated hydrocarbons such as toluene, xylene, Solvesso® 100, 100ND, 150, 150 ND or 200, 200 ND (mineral oil), tetrachloromethane, chloroform, methylene chloride and dichloroethane, and also esters such as ethyl acetate, and alkanecarboxamides such as N,N-dimethyloctanamide and N,N-dimethyldecanamide. In addition come vegetable oils and modified oil (for example by methylation, ethylation and also hydrogenation and hydration) based, for example, on rapeseed oil, maize kernel oil, coconut oil or the like. Particular preference is given to using mineral oil, very particular preference to using solvents based on a from dialkylnaphthalene (for example diisopropylnaphthalene), and mixture of 1-methyl- and 2-methylnaphthalene and naphthalene (for example Solvesso® 200 ND products, CAS No.: 64742-94-5).

Suitable carrier materials g) are selected from the group of the Silica, ton, silicates.

The capsule suspension concentrates according to the invention are of excellent suitability for application of the active agrochemical ingredients present to plants and/or the habitat thereof. They ensure the release of the active components in the respective desired amount over a relatively long period of time.

The capsule suspension concentrates according to the invention can be used in practice either as such or after dilution with water. Application is effected by customary methods, i.e., for example by pouring or spraying.

The application rate of capsule suspension concentrates according to the invention may be varied within a relatively wide range. It is guided by the active agrochemical ingredients in question and by the content thereof in the microcapsule formulations.

A preferred use of the capsule suspension concentrates according to the invention is as a herbicide in cereals and oilseed rape, most preferably in winter barley and in this context in a pre-emergence method and in a post-emergence method. Preference is therefore given to use in an autumn application shortly after the sowing of the cereal and shortly before or shortly after germination of the weeds and in particular weed grasses.

The capsule suspension concentrates according to the invention can be produced by known processes, for example as mixed formulations of the individual components, optionally with further active ingredients, additives and/or customary formulation auxiliaries, and these are then applied in a customary manner diluted with water, or as tankmixes by joint dilution of the separately formulated or partly separately formulated individual components with water. Likewise possible is the application at different times (split application) of the separately formulated or partly separately formulated individual components. It is also possible to apply the individual components or the capsule suspension concentrates according to the invention in a plurality of portions (sequential application), for example by pre-emergence applications followed by post-emergence applications or by early post-emergence applications followed by medium or late post-emergence applications. Preference is given to the joint or immediately successive application of the active ingredients in the respective combination.

Accordingly, the present invention further provides a method of controlling unwanted plants in plant crops, which is characterized in that the capsule suspension concentrates according to the invention are deployed on the plants (for example harmful plants such as mono- or dicotyledonous weeds or unwanted crop plants) or the area on which the plants grow.

Unwanted plants are understood to mean all plants which grow at sites where they are unwanted. These can be, for example, harmful plants (e.g. mono- or dicotyledonous weeds or unwanted crop plants).

Monocotyledonous weeds come, for example, from the genera: Aegilops, Agropyron, Agrostis, Alopecurus, Apera, Avena, Brachiaria, Bromus, Cenchrus, Commelina, Cynodon, Cyperus, Dactyloctenium, Digitaria, Echinochloa, Eleocharis, Eleusine, Eragrostis, Eriochloa, Festuca, Fimbristylis, Heteranthera, Imperata, Ischaemum, Leptochloa, Lolium, Monochoria, Panicum, Paspalum, Phalaris, Phleum, Poa, Rottboellia, Sagittaria, Scirpus, Setaria, and Sorghum.

Dicotyledonous weeds come, for example, from the genera Abutilon, Amaranthus, Ambrosia, Anoda, Anthemis, Aphanes, Artemisia, Atriplex, Bellis, Bidens, Capsella, Carduus, Cassia, Centaurea, Chenopodium, Cirsium, Convolvulus, Datura, Desmodium, Emex, Erysimum, Euphorbia, Galeopsis, Galinsoga, Galium, Hibiscus, Ipomoea, Kochia, Lamium, Lepidium, Lindernia, Matricaria, Mentha, Mercurialis, Mullugo, Myosotis, Papaver, Pharbitis, Plantago, Polygonum, Portulaca, Ranunculus, Raphanus, Rorippa, Rotala, Rumex, Salsola, Senecio, Sesbania, Sida, Sinapis, Solanum, Sonchus, Sphenoclea, Stellaria, Taraxacum, Thlaspi, Trifolium, Urtica, Veronica, Viola and Xanthium.

Preferably, the capsule suspension concentrates according to the invention are used to control the weed of the Alopecurus myosuroides species HUDS (or black grass).

The invention also provides for the use of the capsule suspension concentrates according to the invention for control of unwanted plant growth, preferably in crops of useful plants.

If the capsule suspension concentrates according to the invention are applied to the soil surface before germination, either the emergence of the weed seedlings is prevented completely or the weeds grow until they have reached the cotyledon stage, but then they stop growing and ultimately die completely after three to four weeks have passed.

When the capsule suspension concentrates according to the invention compositions are applied post-emergence to the green parts of the plants, growth likewise stops rapidly a very short time after the treatment, and the weed plants remain at the growth stage at the time of application, or they die completely after a certain time, such that competition by the weeds, which is harmful to the crop plants, is thus eliminated very early and in a sustained manner.

The capsule suspension concentrates according to the invention are notable for a rapid onset and long duration of herbicidal action. Said properties and advantages are beneficial in practical weed control in order to keep agricultural crops clear of unwanted competing plants and hence to ensure and/or increase the yields in terms of quality and quantity. These novel compositions markedly exceed the technical state of the art with a view to the properties described.

Even though the capsule suspension concentrates according to the invention have excellent herbicidal activity against monocotyledonous and dicotyledonous weeds, there is only insignificant damage, if any, to crop plants of economically important crops, for example dicotyledonous crops such as soya, cotton, oilseed rape, sugar beet, or gramineous crops such as wheat, barley, rye, oats, millet/sorghum, rice or corn. For these reasons, the capsule suspension concentrates according to the invention are highly suitable for selective control of unwanted plant growth in agriculturally useful plants or in ornamental plants.

In addition, the capsule suspension concentrates according to the invention have excellent growth-regulatory properties in crop plants. They intervene in the plants' own metabolism with regulatory effect, and can thus be used for the controlled influencing of plant constituents and to facilitate harvesting, for example by triggering desiccation and stunted growth. In addition, they are also suitable for general control and inhibition of unwanted vegetative growth without killing the plants. Inhibition of vegetative growth plays a major role for many mono- and dicotyledonous crops since this can reduce or completely prevent lodging.

By virtue of their herbicidal and plant growth regulatory properties, the capsule suspension concentrates according to the invention can also be used to control harmful plants in crops of genetically modified plants which are known or are yet to be developed. In general, the transgenic plants are characterized by particular advantageous properties, for example by resistances to certain pesticides, in particular certain herbicides, resistances to plant diseases or pathogens of plant diseases, such as certain insects or microorganisms such as fungi, bacteria or viruses. Other specific characteristics relate, for example, to the harvested material with regard to quantity, quality, storability, composition and specific constituents. For instance, there are known transgenic plants with an elevated starch content or altered starch quality, or those with a different fatty acid composition in the harvested material.

Preference is given to the use of the capsule suspension concentrates according to the invention in economically important transgenic crops of useful and ornamental plants, for example of gramineous crops such as wheat, barley, rye, oats, millet/sorghum, rice, oilseed rape and maize. Preferably, the compositions according to the invention can be used as herbicides in crops of useful plants which are resistant, or have been made resistant by genetic engineering, to the phytotoxic effects of the herbicides. Particular preference is given to use on wheat, barley, rye and oilseed rape, preferably winter oilseed rape.

When the capsule suspension concentrates according to the invention are employed in transgenic crops, not only do the effects toward harmful plants observed in other crops occur, but frequently also effects which are specific to application in the particular transgenic crop, for example an altered or specifically widened spectrum of weeds which can be controlled, altered application rates which can be used for the application, preferably good combinability with the herbicides to which the transgenic crop is resistant, and influencing of growth and yield of the transgenic crop plants.

The present invention also further provides a method of controlling unwanted plant growth, preferably in crop plants such as cereals (e.g. wheat, barley, rye, oats, rice, corn, millet/sorghum), more preferably in monocotyledonous crops such as cereals, for example wheat, barley, rye, oats, crossbreeds thereof, such as triticale, rice, corn and millet/sorghum, wherein one or more capsule suspension concentrates according to the invention are applied to the harmful plants, plant parts, plant seeds or the area in which the plants grow, for example the area under cultivation in the. Preferably, the capsule suspension concentrates according to the invention are applied pre-emergence and post-emergence. More preferably pre-emergence.

The invention therefore also provides for the use of the capsule suspension concentrates according to the invention for control of harmful plants in transgenic crop plants.

A further preferred use of the capsule suspension concentrates according to the invention is as insecticide.

A preferred direct treatment of the plants is leaf application, i.e. the capsule suspensions according to the present invention are applied to the foliage, wherein the treatment frequency and the application rate should be matched to the infestation pressure of the respective pest.

In the case of systemically active substances, the capsule suspensions according to the present invention also reach the plants via the root system. The plants are then treated by the action of the capsule suspensions according to the present invention on the plant's habitat. This can be, for example, by drenching or mixing into the soil or the nutrient solution, i.e. the location of the plant (e.g. soil or hydroponic systems) is soaked with a liquid form of the capsule suspensions according to the present invention, or by soil application, i.e. the capsule suspensions according to the present invention are introduced in solid form (e.g. in the form of granules) into the location of the plants, or by drip application (“drip”, often also referred to as “chemigation”), i.e. the capsule suspensions according to the present invention are introduced by means of surface or underground drip pipes over certain periods of time together with varying amounts of water at defined locations near the plants. In the case of water rice crops, this can also be done by metering the compound of the formula (I) into a solid application form (for example as granules) into a flooded rice field.

The capsule suspension concentrates according to the invention are outstandingly suitable for the application of the agrochemical active substances contained to plants and/or their habitat. They ensure the release of the active components in the desired amount over a longer period of time. The capsule suspension concentrates according to the invention can be used in practice either as such or after prior dilution with water. The application takes place according to usual methods, e.g. by pouring, spraying or spraying.

The application rate of capsule suspension concentrates according to the invention can be varied within a relatively wide range. It depends on the respective agrochemical active ingredients and their content in the microcapsule formulations.

The capsule suspension concentrates according to the invention can be prepared by known methods e.g. are produced as mixed formulations of the individual components, if appropriate with further active ingredients, additives and/or customary formulation auxiliaries, which are then diluted with water in the customary manner, or as so-called tank mixes by diluting the separately formulated or partially separately formulated individual components with water. Time-shifted application (split application) of the separately formulated or partially separately formulated individual components is also possible. It is also possible to use the individual components or the capsule suspension concentrates according to the invention in several portions (sequence application).

The invention therefore also provides for the use of the capsule suspension concentrates according to the invention for control of pathogenic fungi and insecticidal pests in crop plants.

The invention further preferably provides for the use of the capsule suspension concentrates according to the invention for treatment of plants where the seed has been treated with safener.

The invention is illustrated by the examples below.

### EXAMPLES

### Substances and Abbreviations Used

The terms used in the examples below have the following meanings:
mefenpyr-diethyl diethyl (RS)-1-(2,4-dichlorophenyl)-5-methyl-2-pyrazoline-3,5-dicarboxylate, (Bayer CropScience AG), melting range 50-55° C.
DCPMI 2-[(2,4-dichlorophenyl)methyl]-4,4′-dimethyl-3-isoxazolidinone (CAS Number 81777-95-9 or IPUAC 2-(2,4-dichlorobenzyl)-4,4-dimethyl-1,2-oxazolidin-3-one, abbreviated hereinafter to DCPMI)
Deltamethrin (1R,3R)—[(S)-α-Cyano-3-phenoxybenzyl-3-(2,2-dibromvinyl)]-2,2-dimethylcyclopropancarboxylat, Bayer AG
citric acid polybasic organic acid
Rhodopol® G xanthan derivative (Solvay)
SAG 1572 silicone defoamer (Momentive)
Silcolapse® 426 R silicone defoamer (Elkem Silicones)
Proxel® GXL preservative (biocide, Proxel)
Solvesso® 200 ND mineral oil, ExxonMobil, naphthalene-free
Break-Thru® Vibrant non-ionic surfactant (Evonik Industries AG)
Desmodur® 44V20L polymeric MDI, Covestro AG, functionality 2.7.
Ongronat 2100 polymeric MDI, Borsodchem, functionality 2.7.
HDA hexamethylene-1,6-diamin, BASF
Kuraray Poval® 26-88 polyvinyl alcohol from Kuraray, about 88% hydrolysed polyvinyl acetate
Reax 88B Lignosulfonate, Ingevity
Borresperse® NA Ligninsulfonat, Borregaard
Capa 300 polycaprolactone ester, Ingevity, OH number 540 mg KOH/g. Functionality 3. Mean Molweight 300 g/mol, based on Alcohol-epsiloncaprolactone.
Capa® 400 polycaprolactone ester, Ingevity, OH number 265-295 mg KOH/g. Functionality 2. Mean Molweight 400 g/mol, based on Alcohol-epsiloncaprolactone.
Capa® 500 polycaprolactone ester, Ingevity, OH 200-215 number mg KOH/g. Functionality 2. Mean Molweight 500 g/mol, based on Alcohol-epsiloncaprolactone.
Capa® 750 polycaprolactone ester, Ingevity, OH 168-177 number mg KOH/g. Functionality 2. Mean Molweight 750 g/mol, based on Alcohol-epsiloncaprolactone.
Vibrathane® 8000 4,4′-MDI based prepolymer based on polyester polyol (adipic acid) with NCO content of 16.5%, LANXESS. The viscosity is 1895 mPas, 30° C., DIN EN ISO 2884-1.
Vibrathane® 8045 4,4′-MDI based prepolymer based on polyester polyol (epsilon-caprolactone based) with NCO content of 10%, LANXESS. The viscosity is 2088 mPas, 50° C., DIN EN ISO 2884-1. At room temperature the product is solid to waxy.

### Examples

Prepolymer I—LT19143

900 g of Ongronat® 2100 were put into a reactor and heated to 50° C. 100 g of Capa® 400 was added and stirring at 80° C. was continued until a NCO content of 25% was reached. The viscosity is 1225 mPas, 30° C., DIN EN ISO 2884-1.

Prepolymer II—LT19145

880 g of Ongronat® 2100 were put into a reactor and heated to 50° C. 120 g of Capa® 500 was added and stirring at 80° C. was continued until a NCO content of 25% was reached. The viscosity is 1215 mPas, 30° C., DIN EN ISO 2884-1.

Prepolymer III—LT19147

880 g of Ongronat® 2100 were put into a reactor and heated to 50° C. 120 g Capa® 750 was added and stirring at 80° C. was continued until a NCO content of 25% was reached. The viscosity is 875 mPas, 30° C., DIN EN ISO 2884-1.

Prepolymer IV—LT20000

880 g of Ongronat® 2100 were put into a reactor and heated to 50° C. 120 g Capa® 400 was added and stirring at 80° C. was continued until a NCO content of 25% was reached. The viscosity is 1060 mPas, 3025° C., DTN EN ISO 2884-1.

General Description of Capsule Suspension (CS) Concentrate Formation

The active ingredients (e.g. Bixlozone, Deltamethrin) were dissolved at 50° C. in the hydrophic solvent (e.g. Solvesso® 200 ND). The isocyanate (e.g. Desmodur® 44V20L, Ongronat 2100) was added. This mixture was added to a solution of protective colloid and dispersant (e.g. Reax 88B), a defoamer (e.g. SAG 1572) and a biocide (e.g. Kathon® CG/ICP) in the needed amount of water. The mixture was emulsified with a disperser at a giving speed and time (e.g. 15 000 rpm for 10 minutes). The required amount of isocyanate reactive group (e.g. hexamethlyendiamine dissolved in water) was added. The resulting reaction mixture is heated up to 70° C. within one hour and kept at 70° C. with gentle stirring for a further 4 hours. After subsequent cooling to room temperature, 0.2 g of a 30% aqueous ammonia solution is added. The mixture is thickened with 0.2 g of Rhodopol® G and 0.4 g citric acid were added. In this way, a microcapsule formulation having with a particle size of appr. 12 μm (d90) is obtained. In the chemical analysis the free, unencapsulated amount of active ingredient as well as the total amount was determined.

I are inventive examples, C are comparisons.

TABLE I
Composition of capsule suspension concentrates; comparative examples

| Component | C1 | C2 | C3 | C4 | C5 | C6 |
|---|---|---|---|---|---|---|
| Mefenpyr-diethyl | 7.14 | | 7.14 | 7.14 | 7.14 | |
| Deltamethrin | | 7.35 | | | | 7.35 |
| DCPMI | 14.23 | | 14.23 | 14.23 | 14.23 | |
| Desmodur ® 44V20L | 1.2 | 0.85 | | | 1.2 | 0.89 |
| Vibrathane ® 8000 | | | 1.3 | | | |
| Vibrathane ® 8045 | | | | 2.15 | | |
| Hexamethlyenediamine | 0.39 | | 0.3 | 0.39 | | |
| Dieethylentriamine | | | | | 0.7 | |
| Break-Thru Vibrant | | | | | | 3.0 |
| Reax 88B | 1.15 | | 1.15 | 1.15 | 1.15 | |
| Borresperse NA | | 0.43 | | | | |
| Kuraray Poval 26-88 | | | | | | 0.46 |
| SAG 1572 | 0.05 | 0.02 | 0.05 | 0.05 | 0.05 | |
| Silcolapse 426R | | | | | | 0.03 |
| Kathon DG/ICP | 0.18 | 0.18 | 0.18 | 0.18 | 0.18 | 0.18 |
| Proxel GXL 20% | | | | | | 0.08 |
| Water add to 100% | | | | | | |
| Solvesso ® 200 ND | 21.4 | 35.9 | 21.4 | 21.4 | 21.4 | 33.1 |
| Speed (U/min) and | 12000 | 3000 | 12000 | 12000 | 12000 | 3000 |
| time (min) | for 1 min | for 1 min | for 1 min | for 1 min | for 1 min | for 1 min |
| Unencapsulated active | <0.5 | <0.5 | 5% | 95% | <0.5 | <0.5 |
| ingredient in wt.-% | wt.-% | wt.-% | | | wt.-% | wt.-% |
| Formulation long time | Given | Given | Not | Not | Given | Given |
| stable according to | | | given | given | | |
| CIPAC MT 46.3 | | | | | | |

Procedure: All tests were carried out using the CIPAC methods common in crop protection (CIPAC=Collaborative International Pesticides Analytical Council; www.cipac.org). The long-term storage was carried out in accordance with CIPAC MT 46.3 at a storage lime of 8 weeks at 40° C. Comparison C1-2 are long lime stable formulation. However, the biodegradability is limited. Comparison 3 can be produced, however, the free unencapsulated active ingredient is too high. This results in an unstable formulation. C4 resulted in an instable formulation already after synthesis. The viscosity of the prepolymer was far too high to make a good microencapsulation process.

C5 was tested in volatility (table 3). As a trifunctional amine (Diethylentriamine) was used, the capsule were so dense that no release of the active ingredient could be found.

TABLE II
Composition of capsule suspension concentrates; inventive capsule suspensions

| Component | I1 | I2 | I3 | I4 | I5 | I6 | I7 | I8 |
|---|---|---|---|---|---|---|---|---|
| Mefenpyr-diethyl | 7.14 | 7.14 | 7.14 | | | | | |
| Deltamethrin | | | | 7.35 | 7.35 | 7.35 | 7.35 | 7.35 |
| DCPMI | 14.23 | 14.23 | 14.23 | | | | | |
| LT19143 - prepolymer I | 1.2 | | | 0.88 | | | 0.88 | |
| LT19145 - prepolymer II | | 1.2 | | | 0.88 | | | |
| LT19147 - prepolymer III | | | 1.2 | | | 0.88 | | |
| LT20000 - prepolymer IV | | | | | | | | 0.88 |
| Hexamethlyenediamine | 0.39 | 0.39 | 0.39 | | | | | |
| Break-Thru Vibrant | | | | 3.0 | 3.0 | 3.0 | 3.0 | 3.0 |
| Reax 88B | 1.15 | 1.15 | 1.15 | | | | | |
| Borresperse NA | | | | 0.46 | 0.46 | 0.46 | | |
| Kuraray Poval 26-88 | | | | | | | 0.46 | 0.46 |
| SAG 1572 | 0.05 | 0.05 | 0.05 | | | | | |
| Silcolapse 426R | | | | 0.02 | 0.02 | 0.02 | 0.02 | 0.03 |
| Kathon DG/ICP | 0.18 | 0.18 | 0.18 | 0.18 | 0.18 | 0.18 | 0.18 | 0.18 |
| Proxel GXL 20% | | | | 0.08 | 0.08 | 0.08 | 0.08 | 0.08 |
| Water add to 100% | | | | | | | | |
| Solvesso ® 200 ND | 21.4 | 21.4 | 21.4 | 32.9 | 32.9 | 32.9 | 32.9 | 32.9 |
| Speed (U/min) and | 12000 | 12000 | 12000 | 4000 | 4000 | 4000 | 4000 | 4000 |
| time (min) | for 1 min | for 1 min | for 1 min | for 1 min | for 1 min | for 1 min | for 1 min | for 1 min |
| Unencapsulated active | <0.5 | <0.5 | <0.5 | <0.5 | n. d. | n.d. | <0.5 | <0.5 |
| ingredient in wt.-% | wt.-% | wt.-% | wt.-% | wt.-% | | | wt.-% | wt.-% |
| Formulation long time | Given | Given | Given | Given | Given | Given | Given | Given |
| stable according to | | | | | | | | |
| CIPAC MT 46.3 | | | | | | | | |

All formulations are long term stable and show good encapsulation. The viscosity of the prepolymer was not too high, so that no problems in the manufacturing process occurred as in example C4.

Determination of the Relative Volatility of the Active Ingredient

A spray liquor (0.5 g of active ingredient/l) is placed onto three Teflon membranes in each case in a glass box open at the top in a laboratory fume hood under a constant air flow of 1.6 m/s at 22° C. and 60% relative air humidity. The residue on the Teflon membranes is determined by HPLC after drying after 0, 24 and 72 h. The volatility is based on the 0 h value.

TABLE 3
Determination of volatility; the amount of active
ingredient is the content of DCPMI in % by weight.

| | Relative volatility |
|---|---|
| Example | in % after 72 h |
| C1 | 85 |
| I1 | 70 |
| I2 | 75 |
| I3 | 72 |
| C5 | 100 |

The results show that all materials give a good reduction of volatility and the inventive capsule material has no disadvantage over the comparative state of the art capsule in the market. Thus, there is no drawback in using ester-containing, biodegradable shell materials for the encapsulation process.

C5 shows no release of the active ingredient under these test conditions. Thus 3 functional amines were disregarded for this development.

Measurement of Biological Efficacy:

Method:

Efficacy tests were conducted in longitudinal plastic containers filled with 5.9 kg of a sandy loam soil, pH 7.1, 1.8% humus. A five cm deep furrow was formed and four corn seeds (var. Ronaldino) were placed in the furrow at a spacing of seven cm. Test formulations were diluted in 4 mL tab water and evenly mixed with 700 g of sandy loam soil. Treated soil was used to fill-up the open furrow and to cover the seeds leading to a total soil weight of 6.6 kgs per container. Infestation was conducted at one day after sowing by pipetting approx. 450 Diabrotica balteata eggs per container. Soil moisture was adjusted to 50% of the specific field capacity and increased to 80%, after emergence of the first neonate Diabrotica balteata larvae. Growing conditions were at a constant temperature of 25° C., 60-70% relative humidity and 14 h of illumination with sodium pressure lamps. The experimental setup comprised three replicates per treatment. Evaluation was conducted 21 days after infestation by counting the number of damaged plants and by measuring the shoot fresh weights per container. The application rate of Deltamethrin was 60 g/ha.

| | | Mean Shoot Fresh |
|---|---|---|
| Example | Healthy Plants/% | Weight/g/plant |
| C6 | 65 | 3.0 |
| I4 | 42 | 3.2 |
| I7 | 92 | 4.3 |
| I8 | 75 | 3.4 |
| UTC not infested | 100 | 3.3 |
| UTC infested | 0 | 0.4 |

All tested examples showed good biological efficacy compared to the untreated control (UTC infested).

Measurement of Biodegradability:

The capsule suspension concentrates were stored at accelerated storage conditions for 2 weeks at 80° C. For CS the decrease of pH was measurement for the liquid material due to the hydrolysis of the ester group thus resulting in free acid. This clearly indicates a destruction of the polymer shell material.

TABLE 4
Hydrolysis of pH adjusted samples to pH 9

| | | pH value after 2 |
|---|---|---|
| Example | pH value initial | weeks at 80° C. |
| C1 | 9 | 8.4 |
| I1 | 9 | 8 |
| I2 | 9 | 8 |
| I3 | 9 | 7.4 |

In the case of the inventive formulations the pH decreases stronger as in the comparative ones. The formation of free acid is a proof of formation of free acid from the ester thus showing increased hydrolysis of the polymer shell material and thus degradation.

TABLE 5
Synthesis of Polymer Shell Material in wt.-%

| | | | | | P4- |
|---|---|---|---|---|---|
| Component | | P1 | P2 | P3 | comparison |
| A | LT19143 - prepolymer I | 1.2 | | | |
| A | LT19145 - prepolymer II | | 1.2 | | |
| A | LT19147 - prepolymer III | | | 1.2 | |
| A | Desmodur ® 44V20L | | | | 1.2 |
| B | Hexamethlyenediamine | 0.39 | 0.39 | 0.39 | 0.39 |

| | | | | |
|---|---|---|---|---|
| Water add to 100% | | | | |
| Solvesso ® 200 ND | 50 | 50 | 50 | 50 |

The Isocyanate Prepolymer A was dissolved in Solvesso 200 ND. The amine B was added to the aqueous phase.

It was stirred for 2 h at room temperature. The solid formed polymer shell (composition as in I1-3) P1-3 was filtered off and dried for 3 days at 120° C. until the sample was weight constant.

The test was performed under OECD 301B conditions (CO2 Evolution Test) for 28 days under aerobic conditions. The test item concentration applied was 20 mg TOC/L with an inoculum concentration of 29.6 mg suspended solids per litre and a total liquid volume of 2 L in 3 L test vessels.

TABLE 6
biodegradation results

| | day 14/degradation | day 28/degradation |
|---|---|---|
| Composition | [%] | [%] |
| P1 | 30 | 38.8 |
| P2 | 26.5 | 35.7 |
| P3 | 17.4 | 25.3 |
| P4 comparison | 15.4 | 21.7 |

The polymers show a faster degradation after 14 and 28 days in comparison to the reference. The degradation is ongoing from day 14 to 28 days thus is indicating a complete degradation over a longer period of time.

1. A microcapsule comprising a polymeric shell, wherein the polymeric shell comprises a polymer comprising
a) at least one NCO terminated polyester-polyol polyisocyanate prepolymer containing at least 2 isocyanate groups and a NCO content >17 wt.-% and a viscosity at 30° C. according to DIN EN ISO 2884-1 <2500 mPa*s, optionally from 400 to 2500 mPa*s, and
b) at least one compound selected from a polyamine with less than 3 amino groups reactive towards NCO groups and/or from other NCO reactive groups selected of alkyl, cycloalkyl, aryl groups with terminal OH or SH groups and/or water.

2. A microcapsule according to claim 1 for an agrochemical formulation.

3. The microcapsule according to claim 1, wherein the polymeric shell comprises in polymerized form the monomers a) and b), comprising:
a) at least one NCO terminated polyester-polyol polyisocyanate prepolymer containing at least 2 isocyanate groups and a NCO content >17 wt.-% and a viscosity at 30° C. according to DIN EN ISO 2884-1 <2500 mPa*s, wherein the molecular weight of the polyester-polyol is 300 to 750 g/mol; and
b) at least one compound selected from a polyamine with less than 3 amino groups reactive towards NCO groups and/or from other NCO reactive groups selected of alkyl, cycloalkyl, aryl groups with terminal OH or SH groups and/or water.

4. The microcapsule according to claim 1, wherein the polymeric shell comprises in polymerized form the monomers a) and b), comprising:
a) at least one NCO terminated polyester-polyol polyisocyanate prepolymer containing at least 2 isocyanate groups and a NCO content >17 wt.-% and a viscosity at 30° C. according to DIN EN ISO 2884-1 from 800 to 2000 mPa*s, wherein the molecular weight of the polyester-polyol is 300 to 750 g/mol; and
b) at least one compound selected from a polyamine with less than 3 amino groups reactive towards NCO groups and/or from other NCO reactive groups selected of alkyl, cycloalkyl, aryl groups with terminal OH or SH groups and/or water.

5. The microcapsule according to claim 1 wherein the microcapsule comprises a polymeric shell and a core, and wherein the core comprises at least one active ingredient.

6. The microcapsule according to claim 1, wherein the polymeric shell is biodegradable according to OECD 301B under aerobic conditions.

7. The microcapsule according to claim 1, wherein the polymeric shell is biodegradable according to OECD 301B under aerobic conditions with at least >17% after 14 days and >25 wt % after 28 days.

8. A microcapsule formulation comprising a microcapsule according to claim 1 the formulation comprising as components:
a) at least one NCO terminated polyester-polyol polyisocyanate prepolymer containing at least 2 isocyanate groups and a NCO content >17 wt.-% and a viscosity at 30° C. according to DIN EN ISO 2884-1 <2500 mPa*s, and
b) at least one compound selected from a polyamine with less than 3 amino groups reactive towards NCO groups and/or from other NCO reactive groups selected of alkyl, cycloalkyl, aryl groups with terminal OH or SH groups and/or water,
c) at least one active ingredient,
d) optionally a water immiscible solvent,
f) at least one protective colloid,
g) at least one additive,
i) water to volume,
wherein components a) and b) form a shell of the microcapsule.

9. The microcapsule formulation according to claim 8, wherein the microcapsule has a median particle size d50 which is optionally between 1 and 50 μm.

10. The microcapsule formulation according to claim 8, wherein the active ingredient is selected from the group of herbicides, safeners, fungicides, insecticides and biologics.

11. The microcapsule formulation according to claim 8, wherein a safener is present if the active ingredient is a herbicide.

12. The microcapsule formulation according to claim 8, wherein
the proportion of a) and b) is between 0.1% and 8% by weight,
the proportion of active agrochemical ingredient c) is between 1% and 50% by weight,
the proportion of organic solvent d) is between 0% and 60% by weight,
the proportion of at least one protective colloid f) is between 0.1% and 5% by weight, and
the proportion of at least one additive g) is between 0.1% and 15% by weight.

13. The microcapsule formulation according to claim 8, wherein
the proportion of a) and b) is between 0.3% and 2.5% by weight,
the proportion of active agrochemical ingredient c) is between 10% and 20% by weight,
the proportion of organic solvent d) is between 0% and 40% by weight,
the proportion of at least one protective colloid f) is between 0.3% and 1.5% by weight, and
the proportion of at least one additive g) is between 0.2% and 3% by weight.

14. A product comprising a microcapsule formulation of claim 8 for application of agrochemical active ingredients to one or more plants, one or more parts of plants, seed and/or a habitat thereof.

15. A microcapsule produced by a process comprising reacting
a) at least one NCO terminated polyester-polyol polyisocyanate prepolymer containing at least 2 isocyanate groups and a NCO content >17 wt.-% and a viscosity at 30° C. according to DIN EN ISO 2884-1 <2500 mPa*s, and
b) at least one compound selected from a polyamine with less than 3 amino groups reactive towards NCO groups and/or from other NCO reactive groups selected of alkyl, cycloalkyl, aryl groups with terminal OH or SH groups and/or water.

16. An NCO terminated polyester-polyol polyisocyanate prepolymer, obtained by reaction of monomeric and/or polymeric diphenylmethane 2,2′- and/or 2,4′- and/or 4,4′-diisocyanate (MDI) and a polycaprolactone ester-polyol, containing at least 2 isocyanate groups and less than 3 isocyanate groups having a NCO content >17 wt.-%, optionally 23 to 27 wt.-% and a viscosity at 30° C. according to DIN EN ISO 2884-1 of <2500 mPas, optionally 400 to 2500 mPas, optionally preferred 800 to 2000 mPas, optionally from 800 mPas to 1500 mPas wherein the polycaprolactone ester-polyol has a molecular weight of 300-750 g/mol, optionally 300 to 500 g/mol.
